(19) United States
(12) Patent Application Publication
(10) Pub. No.: US 2021/0080096 A1
(43) Pub. Date: Mar. 18, 2021

(54) OPTICAL-THERMAL SYSTEM BASED ON TWO-DIMENSIONAL THERMAL PLATES

(71) Applicant: EIDOPIA, S.L., Madrid (ES)

(72) Inventor: Garcia Rodriguez Lucas, Madrid (ES)

(21) Appl. No.: 16/501,095

(22) PCT Filed: Sep. 1, 2017
(86) PCT No.: PCT/ES2017/070595

§ 371 Date: Nov. 23, 2020

(30) Foreign Application Priority Data
Sep. 2, 2016 (ES) P201631151

(51) Int. Cl. F21V 29/76; F21V 29/83

(52) U.S. Cl. CPC F21V 29/763; F21Y 2115/10; F21V 29/83

(57) ABSTRACT

Opto-thermal system for lighting devices with heat dissipating elements, mainly for LED radiation sources, based on two different configurations: parallel and “floating-source” configuration, with one or several bidimensional flat faces, straight or bent, thermally conductive, by phase change or thermal conduction, which directly transmit the heat generated by the radiation source, which is in a central region of the system, in thermal contact with a central area of the plate or in the union of plates, towards peripheral regions, by contact of the flat faces of the plates with the fins, radiators or other flat faces of the body of the device. This system improves the dissipation of heat, the use of space in the devices, and, if it is configured as a floating-source, it makes possible an optical-reflective assembly where all the radiation from the source is reflected and controlled by the reflector.

It is presented and claimed for invention an opto-thermal system to be applied to lighting devices with heat dissipating elements, mainly passives, for LED radiation sources, based on one or several bidimensional plates, with essentially flat faces, thermally conductive by phase change or thermal conduction, which directly transmit the heat generated by the radiation source, which is in a central region of the system, in thermal contact with a central area of the plate or in the union of plates, to peripheral regions of the system, by contact of the flat faces of the plates with fins, radiators or other flat faces of the body of the device.

The aforementioned thermal plates can be integrated into the system in two different configurations with respect to the main direction of radiation of the source: in parallel configuration, where the radiation direction of the source is parallel to the normal direction of the plate in the region of thermal contact; or in floating-source configuration, where it is perpendicular.

The present invention offers, as main advantages, to substantially improve the dissipation of heat in the LED devices that are integrated in it, to simplify the number of components of the system, without the need of specific components for the dissipation and others for the body of the system, maximizing the use of the interior space, and to enable a reflective optical assembly in which the totality of the radiation of the source is reflected and controlled by the reflector in the case of the configuration in floating-source used in combination with a suitable reflector.

### Scope

The proposed system can be framed within the LED lighting devices or other source of radiation characterized by heat dissipation systems, to improve the protection of the source against thermal degradation, but also within the devices characterized by providing means for improvement of the efficiency and optical control, finding application in the sector of general lighting, retail lighting, spectacular lighting, architectural, theatrical, sports, industrial, exterior lighting, street and outdoor lighting, with symmetrical and asymmetrical reflectors, lanterns, wall-washers, projectors, lamps, downlights and cardanics, spotlights, fiber optic radiation injectors/couplers, front panels for medicine or mining, and in the automotive sector, applied to vehicle headlights.

The system can also be integrated as part of bidirectional and unidirectional communication systems, infrared emission heaters (IR), UV radiation applications for the curing of epoxies and other materials, 2D and 3D printing, lithography, disinfection applications, purification and activation of chemical processes by radiation, as well as directional communication or detection systems, static or dynamic image projection systems, photo-curing systems for industry, as well as the growth of plants in horticulture, among others.

### State of the Art

The continuous development of LED (Light Emitting Diode) technology in the lighting industry has led to the conception of new optical and thermal systems associated with this light source that makes possible to improve its performances.

From the thermal point of view, this light source requires heat dissipation systems to avoid overheating the LED and ensure its proper functioning.

Currently, the most common strategy for dissipating the heat of the LED is done by the use of passive heat radiators consisting of a solid base, usually aluminium, in direct contact with the board (PCB) where the LED or LEDs are located, with fins or pin-fins that assist the thermal transfer of heat to the environment by convection (FIGS. 1 and 2). In many cases, these fins are covered by a casing for aesthetic reasons, making heat dissipation difficult.

Due to the large volume and weight of the heatsink the power equipment is normally connected externally, although it can also be integrated into the body of the product itself.

In some cases, active thermal systems are also used, like those based on fans, vibrating membrane systems, or other systems by active pumping of liquid refrigerant.

More recently, and originally developed for dissipation in power electronics in military applications, aerospace, and later for microprocessors and graphics cards, passive dissipation systems based on two-phase thermosyphon tubes, also known as heatpipes, are also used. These are essentially tubes of cylindrical section with a liquid inside them and totally hermetic in a closed circuit, which effectively transmit heat by evaporation, when heated by the radiation source.

Generally, current systems based on heatpipes transmit the heat generated in the LED only through its central zone, that is, in a trunk way along the core or internal region of the system. The transfer of heat from the interior to external regions of the system is done by thermal coupling a plurality of metal fins to these tubes, which release the heat to the outside by convection, as shown in FIG. 3.

Normally, these systems are conceived and designed as an independent and autonomous component, fragile and difficult to be integrated inside the global system: they are exposed to the surrounding of the system, which makes them very vulnerable to external environment, or they are covered, reducing their capacity of heat dissipation.

The patent US20080007954, by Jia-Hao Li, claims a heat dissipation system in which the body is an aluminium extrusion profile with semi-closed tubular gutters, with horseshoe-shaped section, for longitudinally inserting the segments of heatpipe. The system is notably more robust and is better integrated than those previously mentioned, although it has important technical and industrialization difficulties in practice, among which the complexity of inserting the heatpipes by the tubular gutters of the aluminium profile and achieving a good thermal contact on the entire surface of the heatpipes, or alternatively, thermally coupling the LED plate, which has a flat base, with the heatpipes, which are tubes with curved faces. In addition, this solution requires that part of the heatpipe is outside one of the ends of the body of the system, because the heatpipe itself makes butt with the gutter (unless the gutters open more, damaging the contact and the heat transfer between heatpipe and body).

The present invention is similar to the aforementioned patent, since the generated heat is transferred from the inner part of the system to the outermost region, although, in this case, heat is transferred by plates with flat faces instead of tubes because LEDs and LED PCBs are components with an intrinsically flat base. On the other hand, to produce parts with flat surfaces is generally simpler, more precise and more economical than parts with curved surfaces. In addition, the thermal contact between two flat surfaces is technically more efficient, and industrially easier to integrate.

Therefore, the present invention provides a thermal solution based on bidimensional thermal plates coupled to the essentially flat faces of the body of the system, more integrated in the overall system, which allows to substantially improve the use of the volume of the system and the heat transfer to outside, making products more compact, simpler, more powerful, with greater capacity to dissipation of heat and more economical.

On the other hand, from the optical point of view, the demand in the market of lighting and automotive optics that present less glare, greater control of light and more directional and/or narrow and efficient light beams, is difficult to achieve with current technologies due to the following reasons.

A conventional reflector optical system does not allow a total control of the light coming from the LED, since part of it escapes through the opening of the reflector without interacting with it, causing less control of light and annoying glare.

Unlike a classic reflector system, an ideal lens system allows complete control of light, since all light can interact with the lens (or lens system). However, it has two important inherent handicaps: i) The lenses do not allow the total amount of light go across it, since a proportion of unwanted reflections is produced in each transition of matter. These reflections produce optical losses and uncontrolled light, which also causes annoying glare; ii) in addition, the greater the control of the light or the need for very directional and narrow light beams, for geometrical reasons, and since the light source has a specific dimension, the lens size must be greater. Generally, they must be solid to optimize optical performance. Therefore, efficient systems with narrow beams require essentially solid lenses of large dimensions, which hinders the manufacturing process and the feasibility of application, since it involves significant costs of the component (the injection of solid plastic materials with variable thicknesses is complex with the current technologies, partly due to the difficulty of controlling the spatial thermal gradient in the cooling process of the injected material) and its raw material, in addition to the corresponding weight of the material. That is why today there is hardly any competitive solution in the market with a very narrow beam width.

The search for optical solutions that improve these technical difficulties of dispersion, glare, optical losses and unwanted radiation, has led to propose alternative methods based on laser technology, such as BMW company for automotive industry, although it does not improve completely these problems and, nowadays, increases costs.

Currently, optical systems that block part of the radiated light are used in applications where a highly collimated beam is required, such as theatrical or spectacular lighting, which reduces the efficiency and increases the heat of the system.

An optical configuration in which the radiation source is placed in front of a reflector so that all the light interacts with the reflector presents, a priori, several advantages over the other solutions on the market, since there is a complete control of the light without dispersion. We will call this configuration a floating-source configuration and it is characterized by excellent light control and higher visual comfort, free of glare. Its implementation, in practice, is not trivial; It is a technical and industrial challenge for optical, thermal and mechanical issues. The greatest difficulty is that any element that allows positioning and cooling the light source in this configuration blocks the light and negatively disturb the distribution and efficiency of the system. In addition, this disturbance causes, in turn, an absorption of the radiation that increases the difficulty of cooling the system.

There have been several attempts that try to give approximate solutions to the floating-source configuration in the market. Among them stands out the one by MEGAMAN company, according to a technology essentially described in the patent ES2365031, which compromise a reflector split by one or several “solid” walls of a conductive material, such as aluminium, as can be seen in the FIG. 4. An LED light source is placed on each of the faces.

It is noteworthy that the LEDs radiate “parallel” to the surface of the wall in this existing solution. So, approximately half of the light emitted by the source does not interact with the reflector. In this way, to avoid glare, a cap is added which has the purpose of blocking this radiation coming directly from the source. The addition of this cap causes a significant decrease in efficiency. In addition, despite the incorporation of this blocking cap, for geometric reasons, it is not possible to prevent part of the light coming from the source from the system without interacting with the reflector, causing annoying glare and uncontrolled light.

Unlike the aforementioned system corresponding to the patent ES2365031, the system object of the present invention allows the light source to “float” and face the reflector, so that the light of the LED source radiates “perpendicular” to the surface of the plate. In this way, all the light interacts with the reflector, without the need for any additional element that blocks the light, and free of glare. Therefore, the object of the present invention has considerably greater optical efficiency and light control. In addition, this is not based on conducting the heat of the LED by solid metal plates where one of its largest vertices is directly connected to the central part of a dissipation body. On the contrary, it is based, preferably, on a significantly more complex dissipation technology, based on bidimensional hollow plates, that is referred as heatplate in the present document, where heat is extracted from the source by the change of phase from liquid state to vapor state that suffers a liquid in sealed chambers of the heatplate and at low pressure.

It should be noted that the thermal conductivity of aluminium and copper, related with the patent ES2365031, is a maximum of 209 W/(mK) or 385 W/mK, respectively, while the thermal conductivity of a heatplate related with the present invention can reach 10 0000 W/(mK). These high thermal conductivities have an essential impact on the configuration of the system, because they allow the radiation source and the thermal heatplate to be “floating”, without the need for any of its sides or major vertices to be essentially in direct contact with the body of the system, and without any need to cut the reflector, so that the source can be positioned optimally.

On the other hand, some attempts to approximate the floating-source configuration by adding a two-phase thermosyphon tube (heatpipe), such as the HUIZHOU LIGHT ENGINE LTD and CREE systems, collected in the Spanish patent ES2399 387, with its United States version US20090290349, and patent US20100103678, have also been proposed.

The US20090290349 patent essentially states an initial configuration that compromises a cylindrical heatpipe that is thermally coupled to the outer peripherical ring of the outlet of the reflector. Since this heatpipe has an inadequate shape, with curved surfaces, it is not easy to get a good heat transfer to the main body of the system, which weakens its heat dissipation efficiency.

The heat is transferred poorly from the heatpipe to the peripheral circular ring in this system, since the ends of the heat pipe end in a conical shape (due to the manufacturing process). So, any thermal contact between the heatpipe and the other components is difficult to reached, as shown in FIG. 5a, reducing the heat conduction.

An advantages of the present invention is that practically all the surface of the thermal plate in the peripheral region makes direct contact, by flat faces, with the body of the system (FIG. 13), which confers an essential advantage with respect to existing solutions.

In order to improve the difficulties of thermal transfer, the patent US20090290349 proposes a coating in the form of a plate with a “U” section, with flat faces, which allows, by means of tabs, to screw it to the base of the body of the system. However, this thermal coupling between the “round” heatpipe, the “flat” plate and the body, illustrated in FIG. 5b, is generally insufficient. In fact, as described in all its claims, the main heat transfer is made to the surface ring corresponding to the perimeter edge of the outer mouth of the reflector and not to the body of the system itself. However, said ring has limited capacities to transfer heat to the outside.

In addition, the referred system requires additional thermal elements such as cladding (102), which damage the heat transfer. On the other hand, the mechanical pressure exerted to ensure thermal coupling is performed only between the cladding and the body, and not between the cladding and the heatpipe. That is, the critical surfaces that come into play in the heat transfer do not have mechanical pressure, so the heat transfer is drastically reduced.

In conclusion, this type of system presents difficulties in the transfer of heat from the heat pipe to the rest of the system, essentially, because thermally coupling a tube, with rounded surfaces and conical ends, to the body, usually with flat walls, it is mechanically more complex, less efficient and more expensive than coupling a flat plate to flat faces of the body of the system, which is one of the main bases on which the present invention is based.

In fact, due to this essential technical difficulty, the holder of the patent ES2399387, the same as the aforementioned patent US20090290349, renounces systems with a straight heatpipe, since this presents the technical problems already described with respect to the poor heat transfer of the tube Two-phase thermosyphon to the rest of the system: this patent only claims the particular case when the heat pipe has an “S” shape, which increases the contact surface of the heat pipe with the rest of the components, overcoming the problem described and providing technical viability to the system only with heatpipes in “S”.

This result was also concluded after the aforementioned patent by the company CREE, according to its patent US20100103678, which raises only one heatpipe in the form of “S”, which is, according to our knowledge, the only strategy proposed to date to ensure a good Thermal coupling of the heatpipe with the body of the system in floating-source configuration.

In the present invention, a particular system is proposed in which bidimensional thermal plates with flat faces coinciding with flat faces of the body of the system are integrated, which is an improvement with a nuclear repercussion with respect to the existing solutions regarding the construction, thermal transfer, optical efficiency and the costs of components and assembly of the industrial product.

This type of flat, bidimensional thermal plates, are in the process of research, improvement and development in recent years, thanks to the demand for portable electronic consumables such as smartphones, phablets or tablets, with greater computational capacity (more power density), thinner, lighter and more efficient. It is worth highlighting the system presented by Fujitsu in March 2015, Semiconductor Thermal Measurement Modeling and Management Symposium 31 (SEMITHERM), in San Jose, Calif. with a thickness less than 1 mm thick and the capacity to transfer 20 W efficiently.

The present invention allows an essentially new approach to an existing problem: the floating-source configuration, from the conception of a particular construction in which optically and thermally harmoniously coexists, with the help of a bidimensional thermal plate, that apparently seems a conceptually simple change with respect to the state of the art, but that offers a substantial improvement, with a real practical solution to a problem that has not yet been solved.

### Compendium of the Invention

The opto-thermal system based on bidimensional thermal plates, object of the present invention, is formed as part of lighting devices with passive heat dissipating elements, constituted by the following components:

A body with essentially flat faces, which can be extruded, usually aluminium, with a cylindrical or square section, either a standard profile or a special profile for that purpose, although other types of sections with or without some kind of symmetry, with the possibility of a subsequent machining process, or, an injection body, such as, for example, two halves that, once assembled, imprison the flat faces of the thermal plates, or a body of embossing, or notching, or manufactured by any other manufacturing process. This body can have internal fins, with or without air intake inside, external fins or both internal and external fins, or not fins, when the power of the light source and the surface of the body allows it.

A source of radiation or a white light or RGB LED source, or/and another source of radiation outside the visible spectrum, including IR and/or UV radiation, which can incorporate one or more radiation sensors, so as to allow detection of changes or levels of spectral radiation in the spatial and angular region established by the optical subsystem and act accordingly, to provide it with extended functionalities such as activation/regulation of radiation by presence sensors or light sensors, digital information detection and communication, or to adapt the radiation spectrum of the source according to the measured radiation.

An optional optics to direct the beam of light, formed by a lens, matrix of lenses and/or a reflector, surface or solid of transparent material, with reflecting surfaces—specular, semi-specular or white—, or reflectors based on transparent materials with micro-prismatic surfaces that reflect light by total internal reflection, or by means of diffusers, or a hybrid system of the previous ones. The reflectors can have protective glass or a transparent sheet or sheet at the exit of the light.

An optional anti-glare shield, which recesses the light source and improves visual comfort.

A power supply equipment inside or outside the body, for the radiation sources that require it, or an electronic power supply and/or control system controlled by a microcontroller or a microprocessor; and

An optional interconnectivity by means of a socket, such as the Edison E27, E40, GU10, GU5.3, G53 socket, or by means of an electrified rail connector, or any other type of connector, standard or customized, which allow connection to the electrical network, batteries or power system to be used as a lamp, luminaire or radiant device.

The system being essentially characterized by integrating into the lighting devices provided with these described components, as in the particular and non-limiting case of LED lamps and luminaires, a bidimensional flat plate with flat faces, being able to be straight or bent in various geometric shapes resulting on faces with developable surfaces (i.e., whose Gaussian curvature is zero since one of its main curvatures is zero), of a heat conducting material by phase change or thermal conduction, or several of these plates joined together by their middle part, so that they directly transmit the heat generated by the heat source, which is in a central region of the system, in thermal contact with a central point of the plate, or in the union of plates, towards peripheral regions of the system by the ends of the plate or plates, along the back, front or both parts of the system, by contact of the flat faces of the plates with the fins, radiators or other flat faces of the body.

Said plates are described as bidimensional plates because one of their three dimensions, their thickness, is much smaller, in approximately one order of magnitude, than their other two dimensions (length and width).

Although there may be a direct thermal connection between the plate or plates and the source of radiation or the PCB of the source, which may have a folded shape in U to exert a contact between its flat face and the flat faces of the thermal plate, the system can additionally include a thermally conductive base or platform by phase change or by thermal conduction attached to the plate or joint of plates, which thermally connects them to the radiation source.

The system can also have one or more additional internal heat radiators in thermal contact with the plate or plates, in a adjacent region from the light source, on the back or on some side of the body of the lighting device, or a complementary active dissipation subsystem, for example, by integrating a Peltier cell between the platform, which is in contact with the thermal plate, and plate where the source is located, and/or with a fan or vibrating membranes that increases a flow of air and the exchange of heat to the environment.

The bidimensional thermal plates of the system, which are the essential component thereof, consist preferably of thermal plates by phase change, which confine within a very thin hollow structure, with one or several hermetically sealed cavities, a liquid, such as acetone or water, which absorbs and transmits by evaporation the heat generated by the radiation source, although they can also be solid plates of a material with high thermal conductivity, metallic, ceramic, crystalline or other.

Thermal Plates by Phase Change

The phase change thermal plates developed for the intended purpose consist of a hollow body with flat faces, with one or more cavities or hermetically sealed chambers supported by supporting pillars, as many as required depending on the power dissipated, its width and pressure requirements. These chambers have a suitable internal pressure to favor the evaporation of the liquid that confine in the working conditions, which absorbs and transmits the heat through phase change along the extension of the plate.

An essential feature are the supports or pillars of its interior micro-structure that hold the outer flat faces. These allow very thin plates to withstand the internal suction pressure without the faces of the plate being deformed due to the large vacuum of the chambers, while in a heat pipe it is not possible, then, despite having a greater surface thickness, do not have this structural support, which means that, with the required vacuum pressure, the surface bends and collapses in case of trying to give flatness and fineness to the heatpipe, as illustrated in FIG. 16a.

In addition, thanks to these internal structural supports, these flat bars allow flat faces with a very thin material thickness, which can be 0.1 mm thick, so that, on the one hand, a better heat transfer is possible, and on the other hand, plates with a lower thickness, which is also a substantial difference with conventional heat pipes, which have an essentially cylindrical surface with greater thicknesses, which complicates the thermal transfer and affects the optical performance in the floating-source configuration.

Also, since the aforementioned plates can have as many supports as required, they allow modularity in the growth of their width according to the needs of the system, without significantly affecting the optical performance.

The following different manufacturing technologies have been proposed for the bidimensional phase change plates, which are described below:

a) Extrusion plates by phase change: constituted by extrusion profiles, usually aluminium, with hollow channels and longitudinal hermetic to the extrusion direction, which favour the transfer of heat in said direction. These extruded plates can be bent industrially both with respect to the flat faces and with respect to the edges of the plate. They can also be divided into two halves with independent cameras, closing the central part with a press hit.

b) Laminated plates by phase change: constituted by a sandwich structure of two sheets or thermally conductive films, of different materials and textures, preferably of copper or aluminium (although other films, plastics or other materials are also valid, since if they are sufficiently thin, they efficiently conduct heat), with an internal hollow cavity, hermetically sealed at their ends, or sealed by two other external plastic films, such as PET, by a vacuum-heat-sealing process, with various structural supports internal supports that ensure the interior space of evaporation and condensation.

The inner faces of said sheets or conductive films that delimit the cavities of these plates can incorporate an internal material or structure that favours the liquid transport by capillarity, called wick. Specifically, a second layer of porous structure can be adhered, which can be, for example, a copper mesh, copper foamed metal film, or the resulting structure of a process sintering of metallic powder, which, by capillarity, is soaked by the fluid and serves as a wick.

It is also possible to achieve a similar effect that favours capillarity with a superficial treatment of the inner face of the copper film (or other material), such as a textured, fluted or structured chemical, mechanical, electrical or laser.

This type of component is usually called heatspread when the two larger dimensions of the plate are similar. In the present invention, the dimension that crosses the reflector diametrically is usually greater, so it could be called heatplate.

The internal channels of these thermal plates can be in closed loop and contain an internal structure that exerts a difference of pressure (pumping pressure), by capillarity and geometry, enough to induce a closed flow, without significantly dependence on the gravity force (loop heatplate), or active elements such as a pump or similar, analogous to the aforementioned solution presented by FUJITSU in SEMITHERM 2015.

This implementation also allows bending and making “U”-shaped plates, for example, like the one integrated in the system of FIGS. 21 and 23. In addition, laminated thermal plates allow to simplify the number of components by combining several plates into one, and developing more complex shapes, as shown in FIG. 26.

All the thermal plates by phase change can have an internal division of the channels for optimization under change of orientation of the system, since this one is dependent on the gravity. This division is usually carried out in the region of contact with the source, normally dividing the plate into two similar half-plates.

Solid Sheets.

The bidimensional thermal plates that are part of the system can also be solid plates of materials with high thermal conductivity, either of metallic materials, such as copper or aluminium, ceramics, or crystalline, partially crystalline synthetic materials or derived crystalline compounds, example, carbon, such as diamond, carbon graphite or nano-tubes (at least periodic crystal in a spatial dimension).

These plates can also be a multilayer plate, formed by several layers or films, such as those derived from graphite (pyrolytic graphite sheet) and other layers that allow their adhesion, or by a blend of materials such as ABS, nylon, polycarbonate, silicones, with addition of some other material, such as graphite, graphene, carbon nanotubes, boron nitride (BN), aluminium nitride (AlN), or others.

The mechanical fastening of all these bidimensional thermal plates with the body of the system can be carried out with screws, by sliding, with clips, clamped by another supplementary piece, like a sheet inserted also in a slide, by a strip, by means of glue, adhesive or double-sided film, by magnetic pressure or by any other known method that ensures a convenient thermal contact.

Preferably, these plates have a metallic, black or white finish, although other finishes are also perfectly valid, including different finishes on the same plate.

One or more electronic boards or lines of power and/or communication that feed and/or control the source of radiation can coexist, or form part of the plate inside the thermal plates.

All these plates can be presented into the system according to two different configurations with respect to the main direction of radiation of the light source: in “parallel configuration”, where the main direction of the radiation of the source is parallel to the normal direction of the plate in the region of contact with the source, which favors an optimal heat transfer between the light source and the peripheral walls of the body of the system, or, in perpendicular configuration, which we will call “configuration in floating-source”, where such directions are perpendicular, which makes possible an essentially reflective optical system whereby all of the radiation from the source is reflected by the reflector, with good heat dissipation and good control of the radiation, minimizing the disturbance of light with the thermal system.

Parallel Configuration.

The radiation source, which has a flat base, is coupled to the flat face of the thermal plate in parallel configuration, so that the direction of radiation of the source is parallel to the normal of the plate in the contact area between the source and the plate.

Although these plates are generally symmetrical with a “U” shape, so that the heat is transmitted to opposite sides of the body, typical for a symmetrical product, non-symmetrical plates, such as “L”-shaped plates, are also possible, where the heat only is transmitted along one side of the body of the system. Also, the described system can integrate “X” plates, with a single laminated plate or with several plates, which increases the transfer on all sides of the body of the system. In more complex systems, the plate may have branches to optimize the heat transfer, according to the geometry and specific requirements. On the other hand, these plates can reach the back of the device, which increases the capacity of heat dissipation.

This configuration of the system allows the addition of one or several additional heat radiators in solid contact with the flat internal faces of the plate.

Floating-Source Configuration.

The source of radiation is essentially suspended and held by one or several bidimensional thermal plates in floating-source configuration so that all the radiation of the source is emitted in a perpendicular direction to the faces of the plate in the region of contact between the plate and the source, and interacts all of it with the optics, and so that the flat faces of the thermal plate make contact with flat faces belonging to the body of the system. This construction maximizes the thermal transfer to the exterior and, thanks to the flat geometry of the thermal plate, the interaction of the light reflected by a reflector with the thermal system is minimized, improving efficiency, lighting control and visual comfort.

In addition, the floating-source configuration allows extremely narrow and focused light distributions with large reflectors with essentially paraboloidal or elliptical surfaces, as all light interacts with the reflector, which is relatively easy to industrialise.

The plates are generally straight, although in more optimized constructions they can be curved, as, for example, in the form of “U”, or be more sophisticated shape. It also enables cross heatplates in the reflector. In any case, the plate or plates can cut or partially intersect the reflector, although the most usual way is that they only intersect with the anti-glare frame, thermally connecting the radiation source to the body of the projector.

Additionally, a heat radiator can be integrated into the interior of the body connected to the thermal plate, on the edge opposite that to which the source is located, or longitudinally to the body as in the parallel configuration.

The plates can have radiation sources, or LEDs, of side emission whose base or PCB electronic board is on any of the faces of the heatplate as described in FIG. 37.

The main optics can be constituted by a superficial or volumetric reflector, where the surface can be metallized or prismatic. The light source and/or the plate can be totally or partially embedded in the cases in which the optics is constituted by a dielectric material, such as PMMA, PC or silicone. The curvature of the reflector can be designed to minimize the possible interaction of the light reflected by the reflector with the light source itself or its support, including the thermal plate. In order to pre-adapt the light that subsequently affects the main optics, to optimize efficiency, protect the source and/or to shield possible optical leaks from direct radiation, the plates can support an additional optics close to the source of radiation, such as a mini-lens or a mini-reflector.

Due to the opto-thermal characteristics of the floating-source configuration, it is possible to establish a vent opening in the central region of the reflector so as to allow an air flow (or gas or liquid from the environment—if it is in a submerged medium—) that favours the thermal transfer and cooling of the system. The opening can not be visible from any point contained in the radiant surface of the source, as it is shielded by a reflecting plate that re-directs the light properly. To allow an air flow between the anti-glare fence and the optics in order to increase the heat transfer to the surroundings is possible.

The distributions of light radiation can be modified or redistributed by inserting additional optical components such as a lens, a Fresnel lens, a micro-lens array too. A flat sheet of glass or other material such as methacrylate or polycarbonate into the light outlet to protect the system is also possible. These elements can also be placed just before the anti-glare shield and can allow to provide well-defined patterns, such as oval, linear, or square patterns, among others.

The light beam can also be manipulated by axially movable optical elements, by axial displacement of the reflector, the platform, the plate, the lens or micro-lens matrix, as described below by means of drawings.

A flexible reflector or a flexible lens is also proposed which, by means of pressure or mechanical traction, is conveniently deformed to change the distribution of the beam. In these two cases, these optical components are usually silicone or polyurethane.

The described system can be part of an imaging projection system so that the exit of the opto-thermal system can include and illuminate an image-forming subsystem by light transmission, such as a slide, a gobo with a static image, an LCD panel, or a DMD chip, with dynamic images, for example, together with a system of lenses and/or mirrors that focuses and projects this image in a particular region of the space, thanks to the great light control.

In relation to the state of the art, the floating-source configuration with the bidimensional plates and the proposed construction enables a series of essential improvements that are described below:

Thermal Improvements:

Better surface contact and thermal transfer between the body and the thermal plate, and between the source and the plate, since there is a connection between the flat faces of the components, while in existing solutions there are cylindrical heat tubes, whose surface is difficult to thermally couple effectively to the rest of the components of the system, even with the help of additional coatings, making it necessary to bend in “S” the heatpipe to increase the contact area and improve the transfer (expensive process and with large manufacturing deviations and quality problems).

Greater heat dissipation capacity, since the width of the bidimensional thermal plate can be adequately sized for the required power, without increasing the thickness thereof, and, therefore, without significantly affecting the optical performance of the system.

The transmission of heat is made to the external body of the system, while existing solutions do so only towards a peripheral ring of the outlet of the reflector, which has no fins or radiating elements of heat. That is, the present invention also transfers the heat axially, directly to the nuclear part of the body containing convection fins, thanks to the width of the plate and/or the construction of the system, which maximizes the heat transfer capacity of the system to the environment.

The mechanical pressure exerted between the heat plate and the body is normal to the flat contact surface, which improves the thermal contact, contrary to the existing solutions. In fact, patent US20090290349 and ES 2399387 detail a mechanical construction in which the straight heatpipe does not undergo mechanical pressure, but only its cladding. Mechanical pressure has a great influence on the effectiveness of thermal contact between components.

Less number of components, without the need for additional external coating or ring for thermal coupling, which reduces thermal resistance and improves heat transfer.

Lower thermal load of radiation absorbed by the bidimensional thermal plate since its effective area is lower: With the same heat transfer capacity, a bidimensional plate interacts with light much less than a tubular system of existing technologies.

Optical Improvements:

Since the effective area of the plate perceived by the reflected radiation is much lower in a bidimensional thermal plate (very thin) than in a tube (heatpipe), in the first case it suffers less optical losses. The influence of optical performance on the shape and dimension of thermal tubes and plates in a floating-source configuration has been investigated: For a standard configuration with a reflector diameter of 90 mm, the results show that a bidimensional heat plate can reduce optical losses 500% with respect to the alternative with a tubular heat system, equal section and equal heat transfer capacity. This difference, by itself, supposes a substantial improvement on the state of the art and allows to provide a system up to 30% more efficient.

The effective section of the thickness of the plate also influences the distribution of light. A tubular system further disturbs the output radiation of the system, causing unwanted shadows, than a bidimensional plate.

Lower Costs:

Lower costs of components, since the basic system of the present invention in floating-source, essentially requires only one reflector, a bidimensional plate, an LED plate and a body, if need of additional components. In addition, the thermal plate can be contained in a plane, without needing to bend, avoiding the industrial problems of bending it in “S” as in the existing solutions.

Lower assembly costs, because the basic components can be integrated by pressure, without need of tools. In particular, the construction of the system allows an insertion of the thermal plate by pressure in grooves of the body.

Ease of assembly automation. A bidimensional thermal plate can be inserted in the body of the product in a relatively simple way with automatic and robotic systems, unlike an “S” shaped tube that, due to problems of tolerances in its manufacture, difficulty of identification, grasping, Positioning and insertion of the piece in the system.

The proposed construction is compatible with an extrusion body whose length can be adjusted according to the power of the integrated radiation source, which presents great adaptability, without the need for new developments and new investments associated with a new body.

On the other hand, the described system can be implemented and integrated as a means of unidirectional or bidirectional communication—receives/emits in a particular spatial/angular direction—(and therefore more secure and with less interference), by means of VLC (Visible Light Communication), LIFI (Light Fidelity) technology or any other electromagnetic radiation, including outside the visible spectrum, that can emit the source and detect the sensor. That is, with the incorporation of a radiation sensor near the source, for example, the system, through the source, is able to send digital signals of radiation for data transmission, and the sensor, to receive them, both in a certain direction. In this way it is possible to establish a communication in which the opto-thermal system is the transducer of the signal. This system allows to transmit data at high speed, and is safer than a basic system of communication by laser, because, this last one presents, besides difficulties in the tolerances and disturbances of the direction of radiation, it has a much greater spatial density of power at the same power, which is more likely to cause irreparable damage to living beings by overexposure. Likewise, this device can be connected to a private network, or to a public network, such as Internet (IoT—Internet of Things) through wireless connection of any type, such as WIFI, ZigBee, Z-Wave, Bluetooth or infrared, or through dedicated cable or PLC (Power Line Communication). The power can also be realized by means of PoE (Power on Ethernet). The system can also be controlled by a mobile device, such as a smartphone, electronic tablet, a computer, or similar mobile device.

As an extension of the present invention, a system constituted by a plurality of opto-thermal subsystems described with a particular distribution is also considered, as in a linear or bidimensional matrix.

Therefore, mechanical and optical existing problems are solved by the present invention, by one or several bidimensional thermal plates in floating-source configuration so that its construction maximizes thermal transfer, simplifies the manufacture of the system and minimizes the interaction of the light with it and the total volume of the system.

### Advantages of the Invention

The innovative approach based on bidimensional thermal plates with flat faces in direct contact with also flat faces of the body of the system provides a series of advantages that, without limitation, are presented below:

Thermally:

It improves the transfer and distribution of heat from the radiation source to its surroundings by direct contact of the flat faces of the thermal plates with the body of the system.

Greater air flow inside the system due to the chimney effect, which improves heat transfer.

Allows effective heat sink fins, both external and internal, in the body of the system itself, which increases the dissipation capacity, without the need for additional heatsinks.

Optically, in configuration in floating-source:

More efficient optical system since the disturbance between the optical system and the thermal system is minimized.

It allows more directional radiated output beams and with less light scattering.

Greater control of the output radiation, since all the emission of light interacts with the optical system.

It reduces glare substantially, because direct vision of the light source is not possible.

Mechanically:

Greater use of space, offering more compact products.

Lighter products, because, generally, less material is required than with existing solutions.

Total integration of the thermal system, forming a more compact and harmonious set.

Possibility of systems with lower height, since the thermal system can be extended only on the sides of the system.

Economically and Industrially:

It allows cheaper products, because the body of the product and the dissipator are combined in a single component.

More economical products, because the assembling systems process with bidimensional thermal plates is generally simpler than with heat pipes, in which it is generally necessary to coat and fold it in “S”, and requires less materials and components than a classical system (with an additional solid heatsink).

### FIGURES

At the end of the present document, the following set of figures with drawings and illustrative diagrams of the opto-thermal system based on bidimensional thermal plates and their differences with the closest state of the art, as well as lighting devices are included. LED lighting devices where, with non-limiting character, with its various components and effects produced, in addition to several preferred embodiments of lamps and luminaires with the integrated system are also included.

The head of a standard LED cylindrical projector, with extrusion body and a solid aluminium heat sink with fins or heat radiators is showed in FIG. 1, and a typical projectors with external power equipment (variant a) and internal (variant b and c) is showed in FIG. 2.

Two applications of known heat dissipation systems for spotlight, based on “heatpipes”, are showed in FIG. 3: a) a thermal system with heatpipes and transverse metal plates inside the body, and b) a detail of a thermal system where the heatpipes are in the central part of an aluminium extrusion profile with radial fins.

A diagram of the existing solution according to the patent ES2365031 and the MEGAMAN system is showed in FIG. 4, where the LEDs are located in a wall with basement on the body of the product.

The thermal coupling in a floating-source configuration in two constructions with tubular heat pipes typical of the patents ES2399387 and US20090290349 is showed in FIG. 5. Top (a): bodyless system, where heat is poorly transferred from the heatpipe to the peripheral circular ring since there is no direct contact with the heatpipe. Right (b): section view of the system with body, where the heat flow passes from the heatpipe through the lining, then through the circular ring and through the reflector, until reaching the body of the system where the dissipation fins are located. The thick lines indicate the surfaces that are under mechanical pressure, important for the right transmission of heat.

A possible implementation of a bidimensional thermal plate in a parallel configuration in the body of an LED device with internal dissipation fins is showed in FIG. 6, and an isometric view of the components exploded in the system thus formed in FIG. 7.

A sectioned perspective view of a projector body of cylindrical section without (a) and with (b) internal additional fins in contact with the thermal plate, behind the radiation source is showed in FIG. 8, and an internal power supply is added to both variants of the device in FIG. 9.

An implementation form of the invention in floating-source configuration in an LED device with an extruded body with radial fins in showed in FIG. 10, in which the reflector assembly has been eliminated in drawings c) and d) for a better understanding of the construction.

Two variants in isometric views of the essential elements of the opto-thermal system in floating-source configuration of the device of the previous figure is showed in FIGS. 11 and 12.

An isometric detail drawing of the thermal coupling between a bidimensional plate and the body of the system (a), and a schematic of the mechanical pressure lines of the flat faces of the body on the flat faces of the plate is showed in FIG. 13.

FIG. 14: a drawing illustrating the optical differences between the current solution configuration of LED devices in floating-source, with heat pipe, and the solution of invention with thermal plate. Cross-sectional views of the structure of bidimensional thermal plates by phase change of different modules is showed in FIGS. 15, 16 and 17, including a heatpipe or conventional heat pipe in FIG. 16a for comparative purposes.

A cross section of a bidimensional thermal plate by phase change of multichannel extrusion seen in perspective is showed in FIG. 18.

Different variants of a bidimensional thermal plate by laminated phase change, cross-sectional views are showed in FIG. 9, and the distributions of separators or structural pillars of some of these variants in FIG. 20.

Some implementations of the proposed system in parallel configuration in several LED lighting devices are showed in figures from 21 to 33, some with corresponding breakdowns or component details.

Three optics; (a) superficial, b) and c) volumetric, in floating-source configuration are showed in FIG. 34.

Some examples of the system in the floating-source configuration in several LED lighting devices are shore in figure from 35 to 52, including the headlight of a car (FIG. 51), some with the corresponding component parts.

Different configurations of the floating-source system that allows the output light beam to be varied by axial displacement a) of the reflector, b) of the platform, c) of the plate, d) of the lens or micro array—lente, or by deformation of e) the reflector, or f) the lens are showed in FIG. 53.

Mechanisms that allow to vary the beam of light in some of the ways outlined in the previous figure are showed in FIGS. 54, 55, 56 and 57.

FIG. 58: two schemes of systems in floating-source configuration with mini-reflector (a) and mini-lens (b) close to the radiation source.

Drawing of a system in floating-source configuration associated with an image projection system by means of a gobo or LCD is showed in FIG. 59.

An accent lighting luminaire with a bidimensional thermal plate in a floating-source configuration, chosen as a preferred embodiment of the invention, is showed in FIG. 60.

### FORM OF REALIZATION

Taking as reference the indicated figures it is observed that the opto-thermal system developed is applied to any LED lighting device, or another radiation source of the visible or non-visible spectrum, based on a body with at least some flat faces, where these faces can preferably be the fins themselves or heat dissipation radiators disposed radially or longitudinally in a body of revolution.

The transfer of heat to the outside can be ineffective, since, generally, fins or the hottest parts of the dissipator are not placed outside, like in a typical LED cylindrical projector, as shown in FIGS. 1 and 2, constituted by a radiation source (2) LED, an optics (3) with anti-glare ring (4), a power supply (5), which can be external (FIG. 2a) or internal (FIGS. 2b and 2c), and by a body (1) with a solid and independent extrusion sink (13) with heat radiating fins, due to the intrinsic architecture of the design.

The solid heatsink (13) is essentially replaced by a bidimensional plate with flat faces (7) bent in symmetrical “U”, in thermal contact at its central part with the heat source (FIG. 6) in one of the implementation of the invention, which can be installed in parallel configuration by contact of its two wings with the body of the projector, thus forming a thermal system that improves the transfer of heat from the radiation source to the external part of the device.

The radiation source (2) can be regulated in radiation intensity and in the spectrum or radiation frequency bands, such as a multi-LED system with LEDs of various dominant colours, for example, an RGB system, or LEDs or other source of radiation outside the visible spectrum for special applications, or mixed systems, with radiation in infrared, visible and ultraviolet spectrum. This control can be performed in open loop, or by means of a closed-loop electronic feedback circuit so that the light levels and spectral characteristics are adjusted accordingly to the desired reference.

Essential elements of a spotlight with the characteristics indicated, in parallel configuration with a bidimensional plate (7) in “U” thermally connected to an extrusion body (11) with internal fins is showed in FIGS. 6 and 7. A thermally conductive base or platform (8) is used for coupling the bidimensional plate and the PCB where the radiation source is located, but this plate is dispensable in many cases.

The system can also include an additional heat radiator (9) internally in thermal contact with the plate, in the opposite part to the radiation source, as it is in the projector of cylindrical section shown in FIG. 8b and in the projector with integrated power supply (5) of FIG. 9b.

A simple spotlight system with a cylindrical extruded body (11), a reflector (32) and anti-glare ring (4), in which the opto-thermal system is in a floating-source configuration based on a straight and flat bidimensional plate (7), with internal radial dissipation fins with flat surfaces of the extrusion body (11) for insertion in solid contact with the flat faces of the ends of the plate with the body is showed in FIG. 10. In this case, the heat source (2) is positioned and thermally coupled to the plate by means of a platform (8) in a cylindrical shape, in such a way that all the radiation emitted is directed to the reflector. Essential elements of such system in floating-source configuration where the anti-glare ring and reflector are a single piece is showed in FIG. 11, and where the ring and reflector are two pieces in FIG. 12.

The drawing of FIG. 13b is a detail of a possible thermal coupling between the bidimensional plate (7) and a cylindrical body (1) of the spotlight (FIG. 13a) by contact between the ends of the plate and the radial fins of the heat sink. A diagram of the pressure lines of the body on the plate in the area of contact with the fins (FIG. 13b), the hermetic internal cavities (71) and the structural supports (72) of a thermal plate by phase change are showed according by a cross-sectional view. The black lines represent the pressure surfaces, which are precisely those involved in the transfer of heat.

From a thermal point of view, the difference of the invention with respect to the state of the art for configuration in floating-source illustrated in the FIG. 13 versus FIG. 5: since the curved wall of the section heat pipe cylindrical (101) are in partial and poor contact with the flat faces of the cladding (102) in this last case, without any mechanical pressure of any kind on the heatpipe, and, furthermore, so that the flow of heat is hindered by the passage through multiple components, each with a thermal resistance, before reaching the body with fins. In fact, the ends of the heatpipe, which are the most critical regions in the transfer of heat by contact with the rest of the components, ends in a conical shape, which makes this thermal contact and heat transfer even more difficult, unlike the proposed solution, which is a direct and flat contact between faces of the thermal plate and the body under pressure.

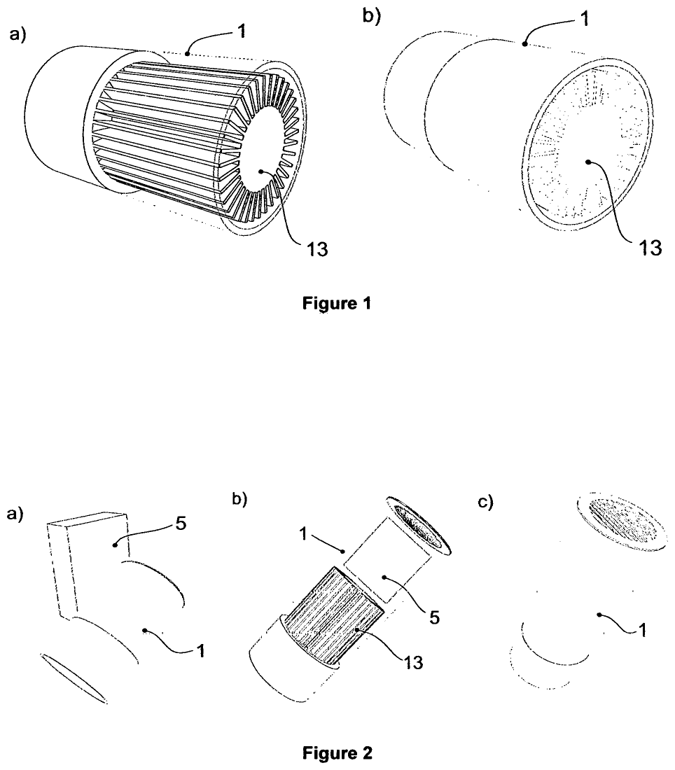

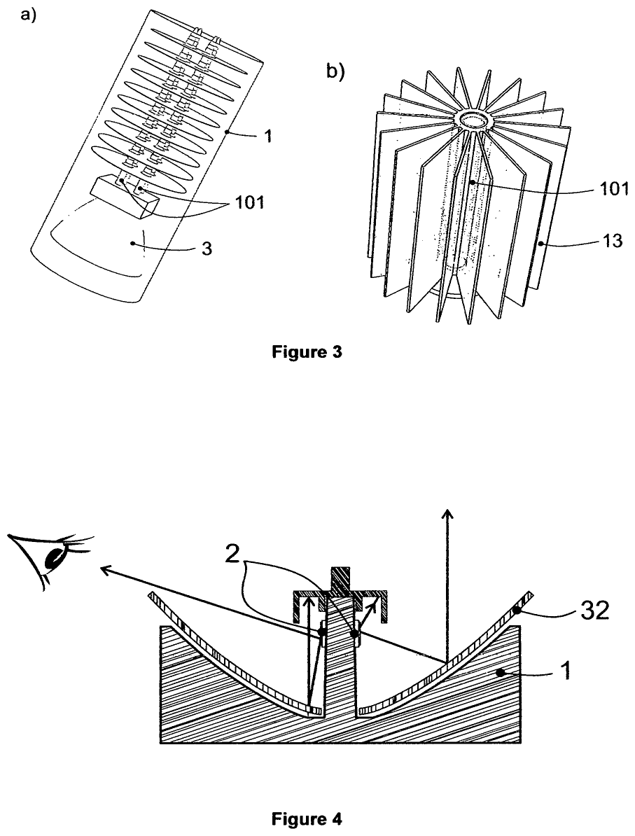

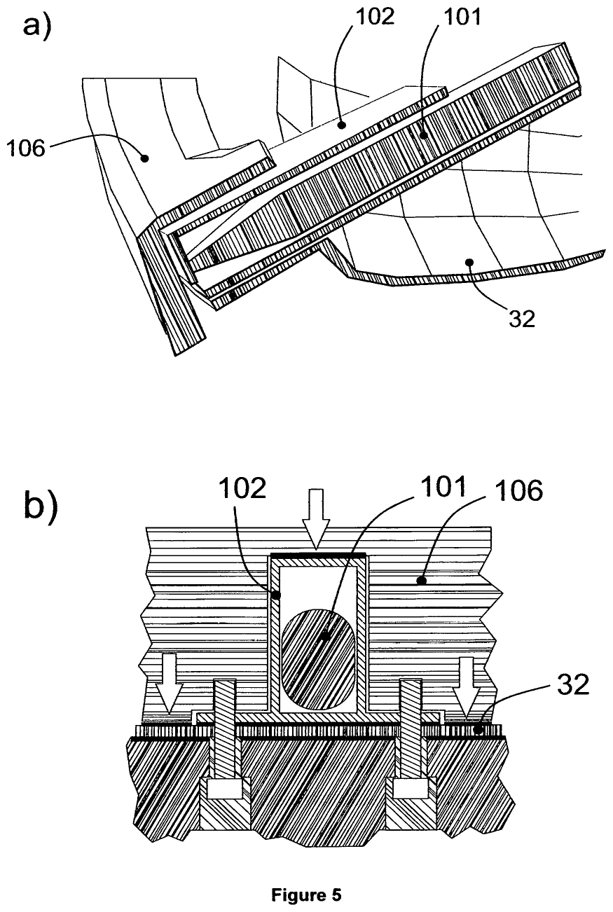

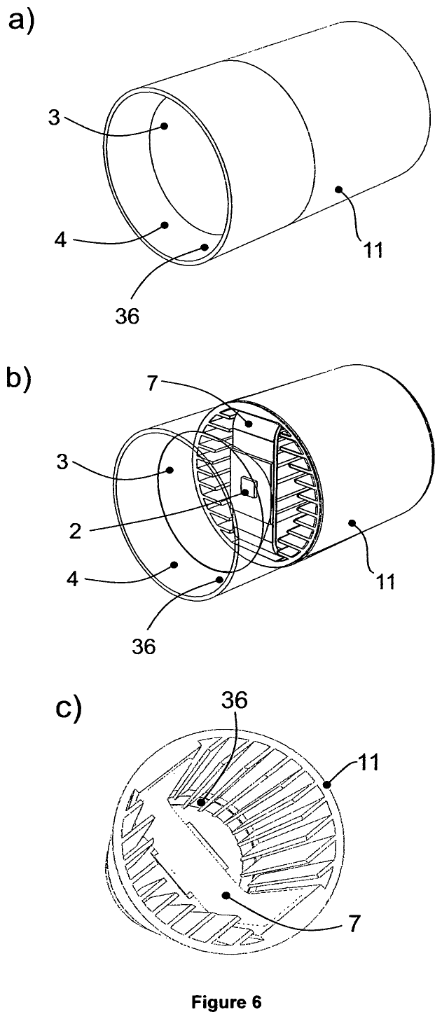

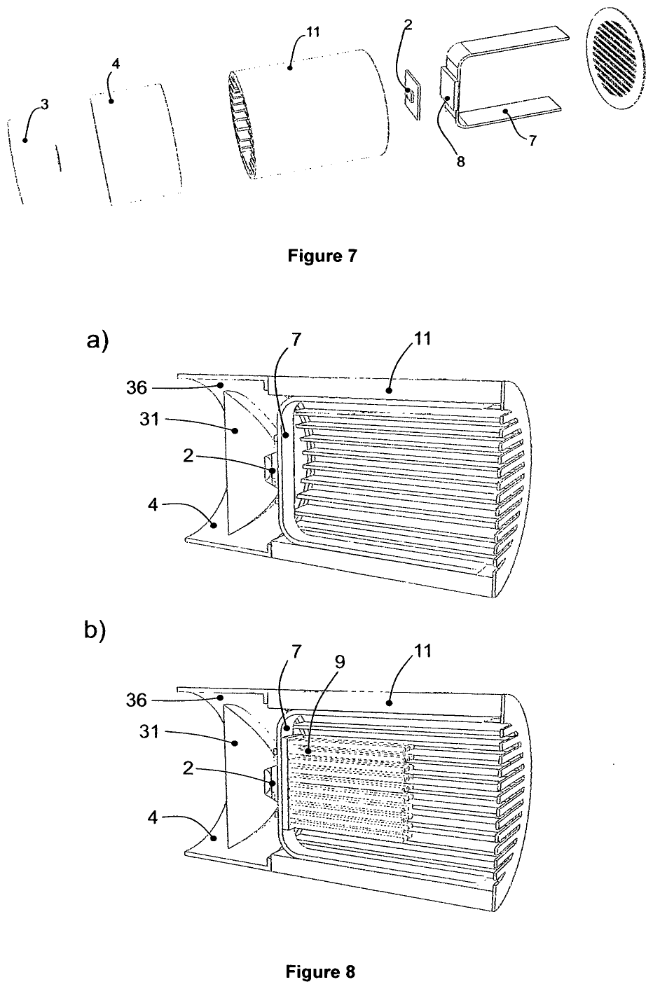

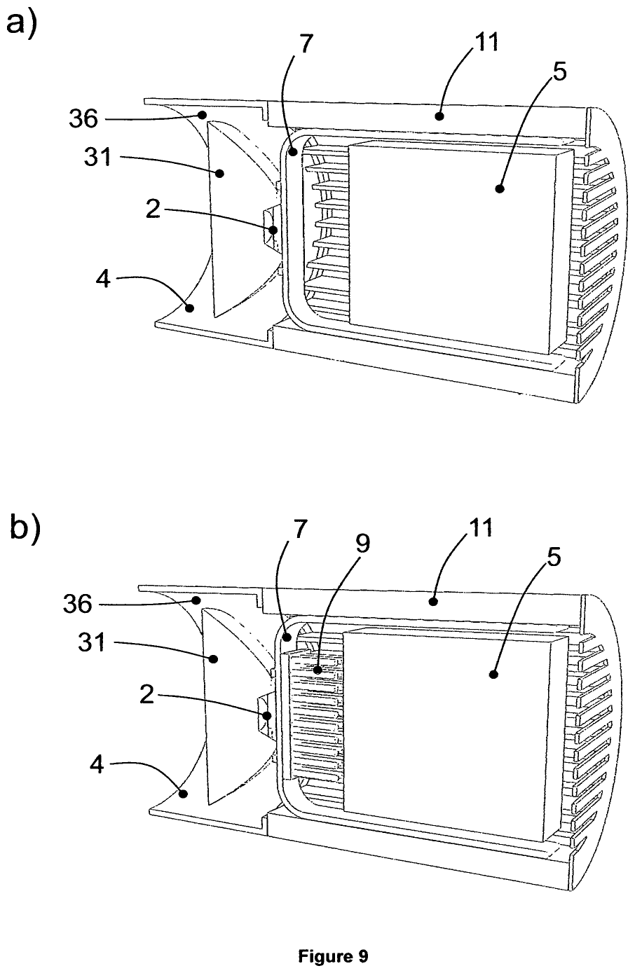

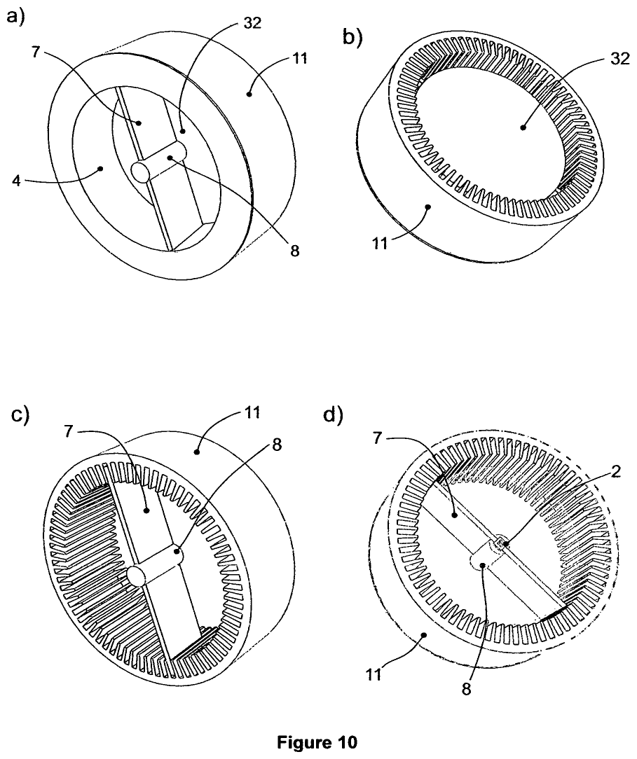

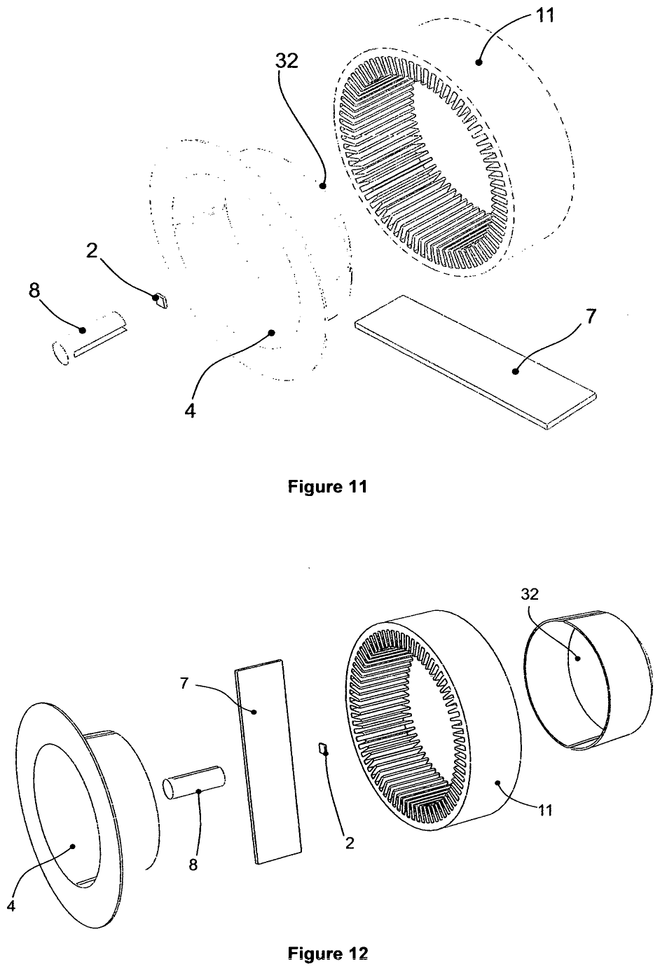

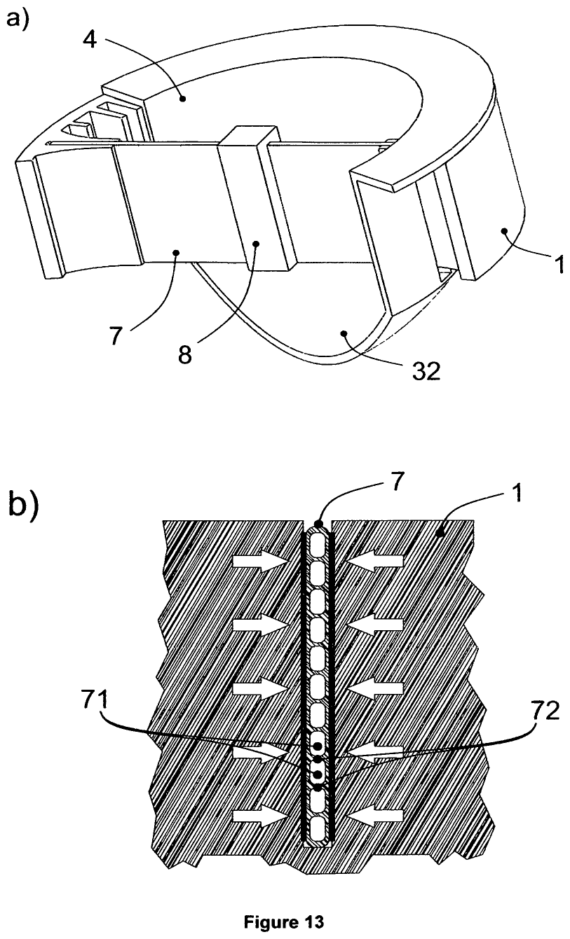

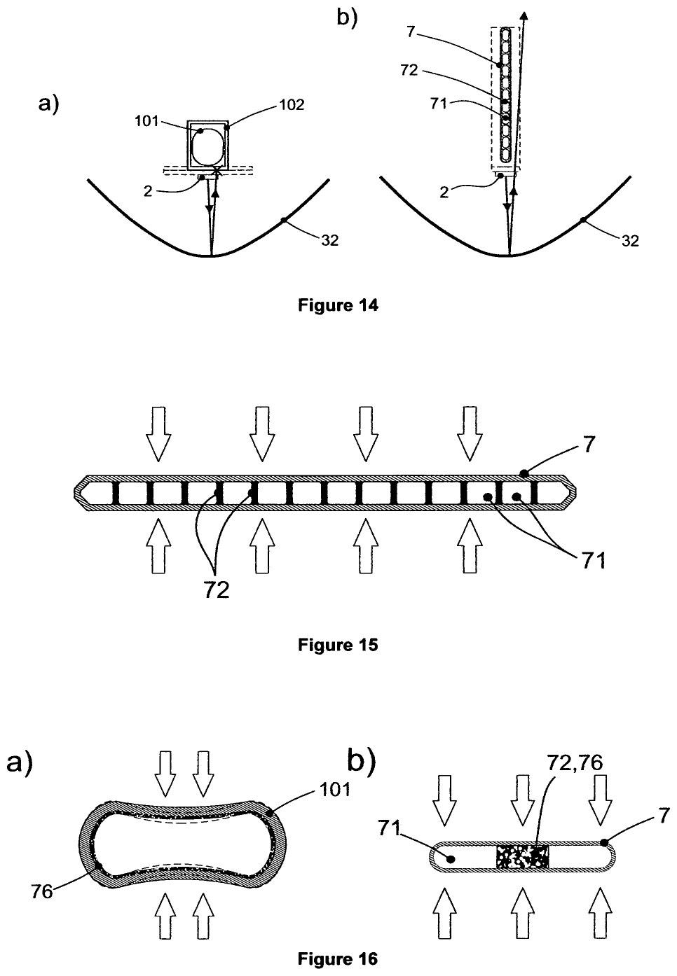

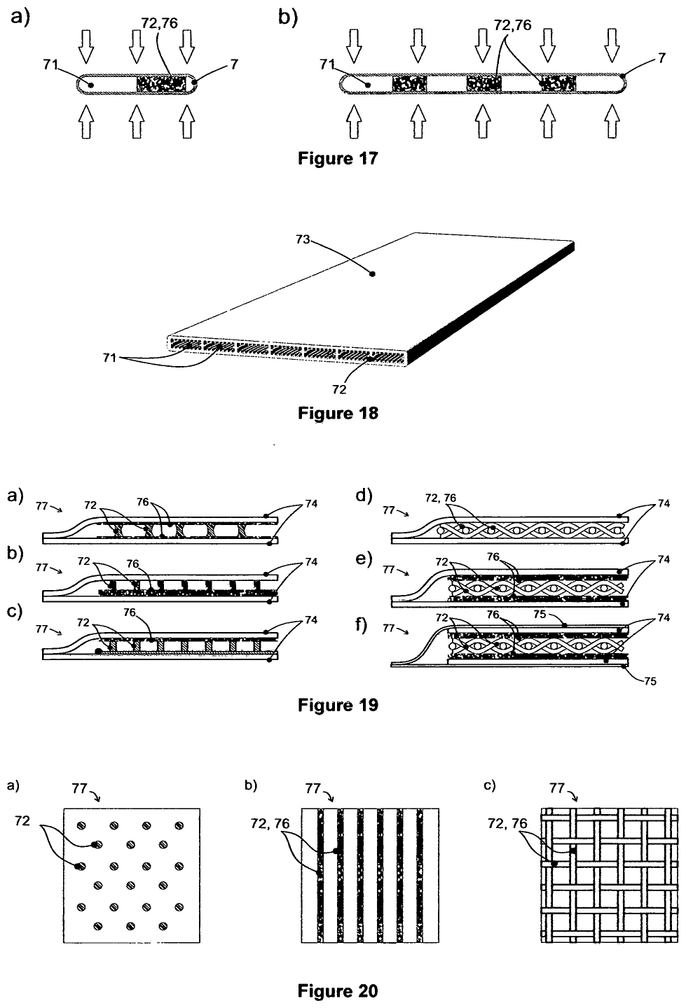

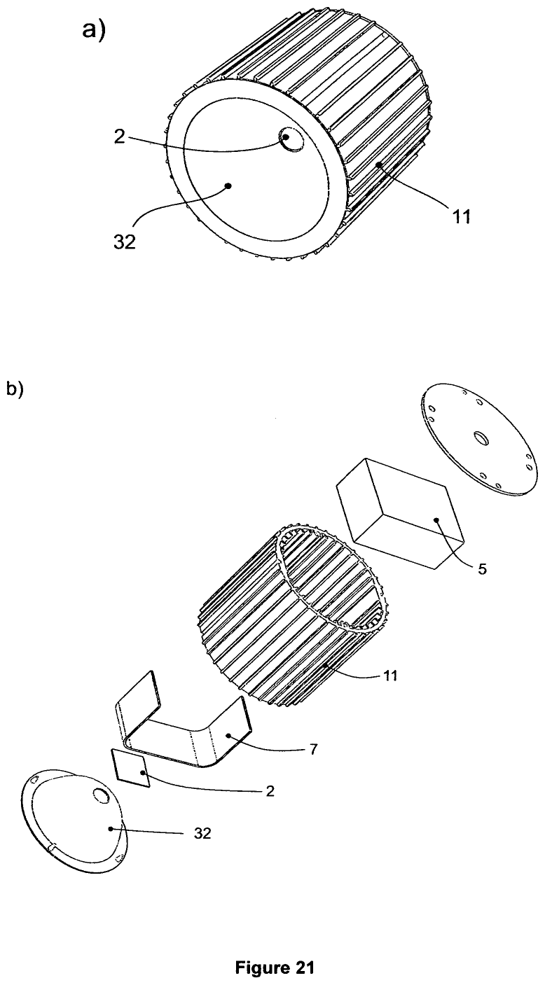

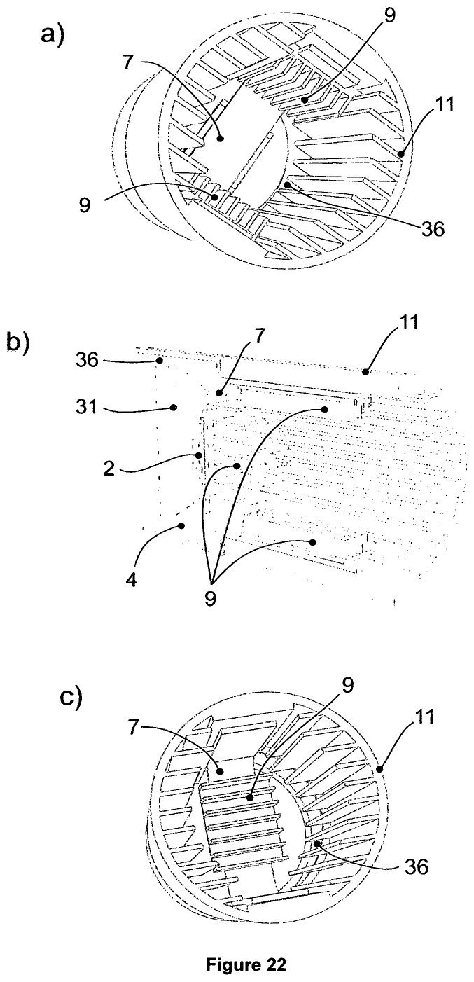

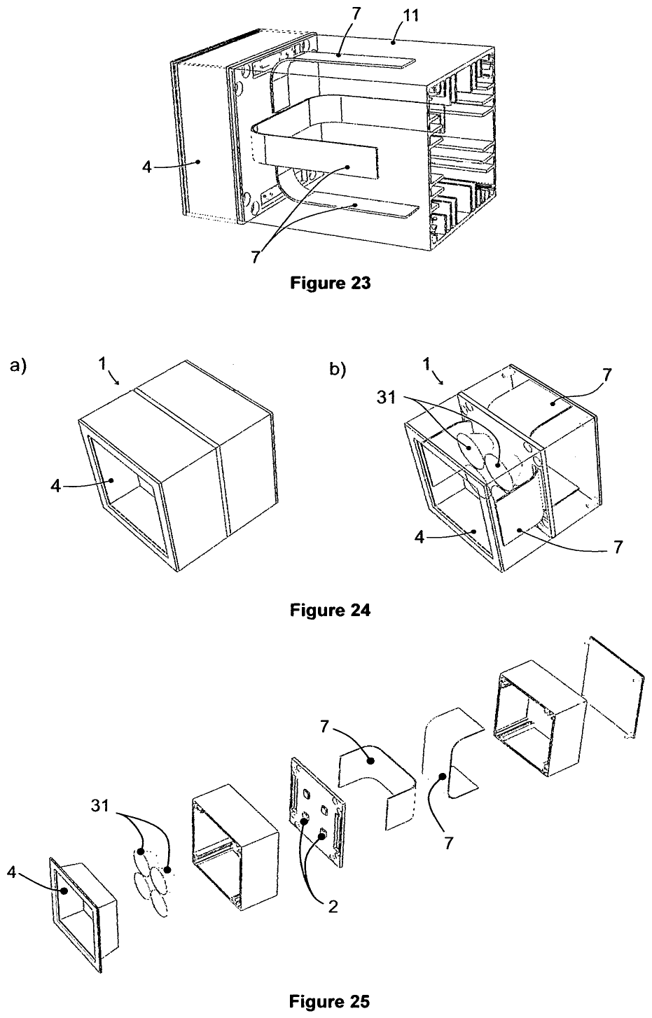

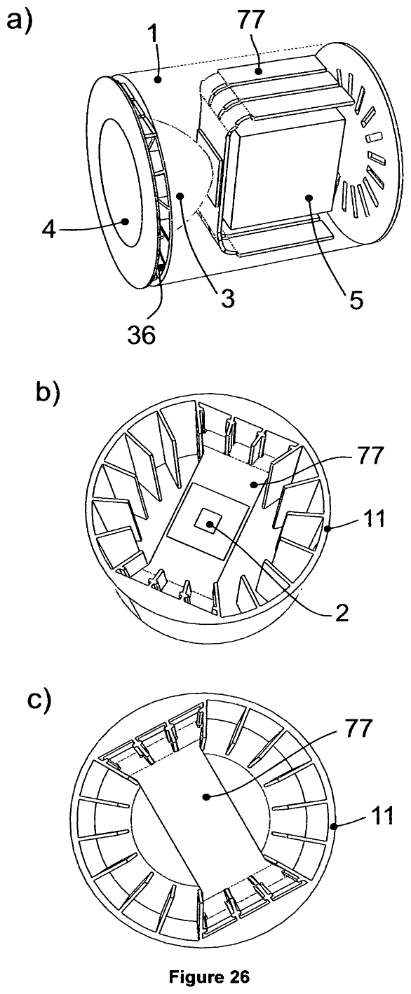

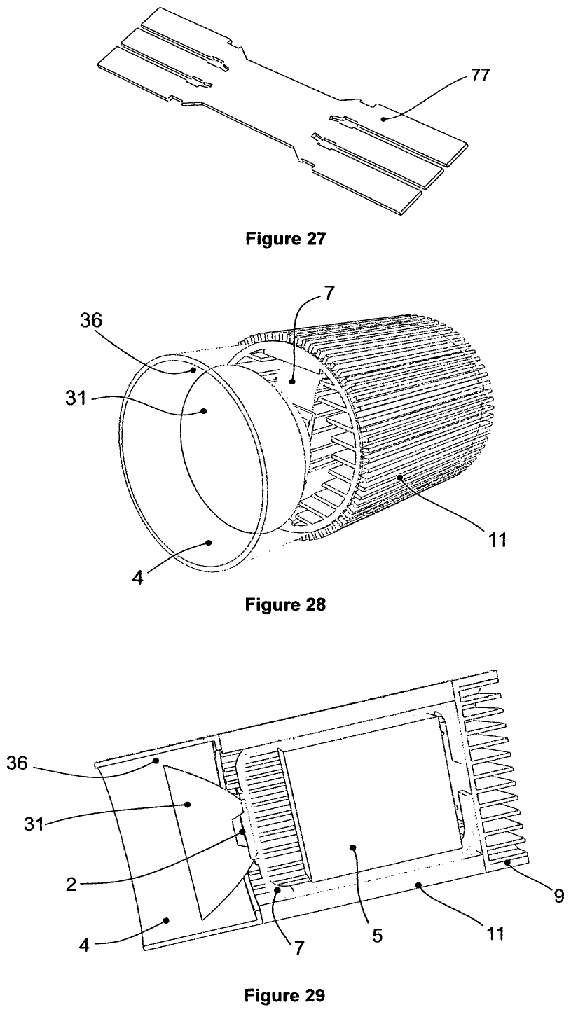

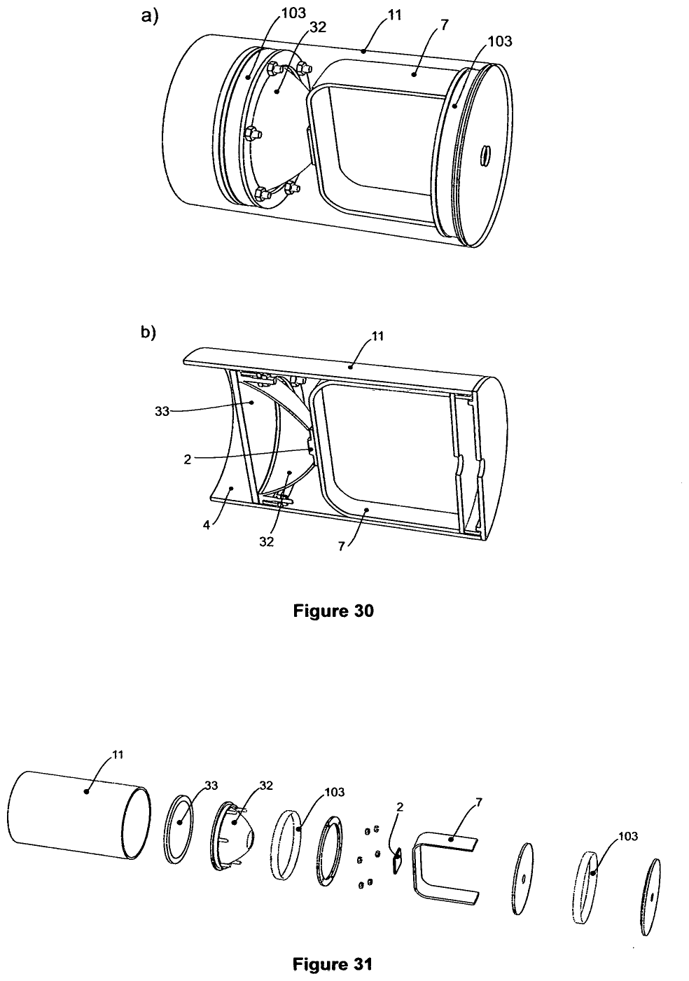

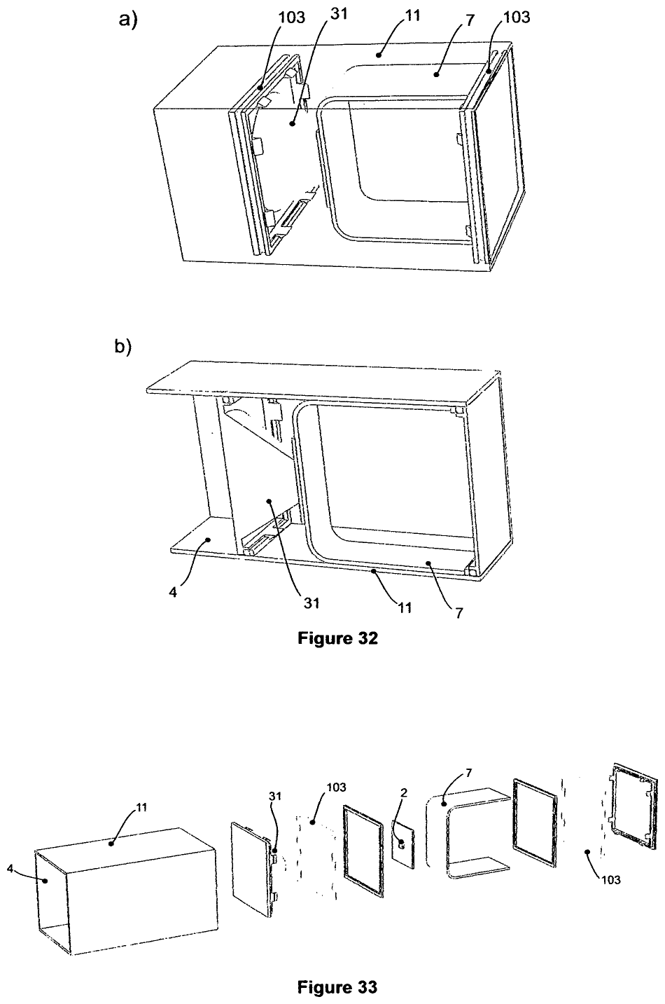

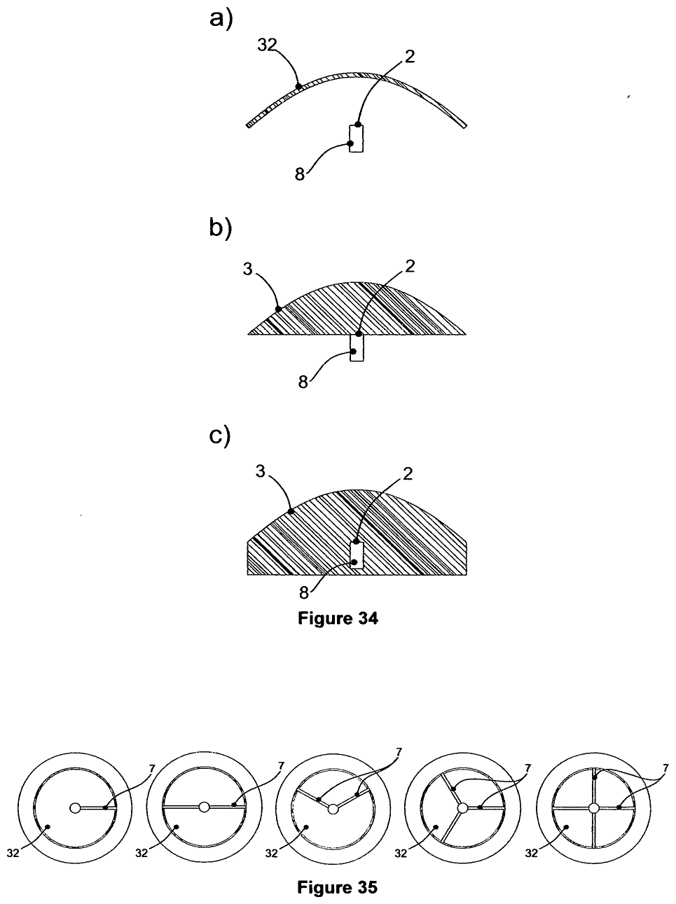

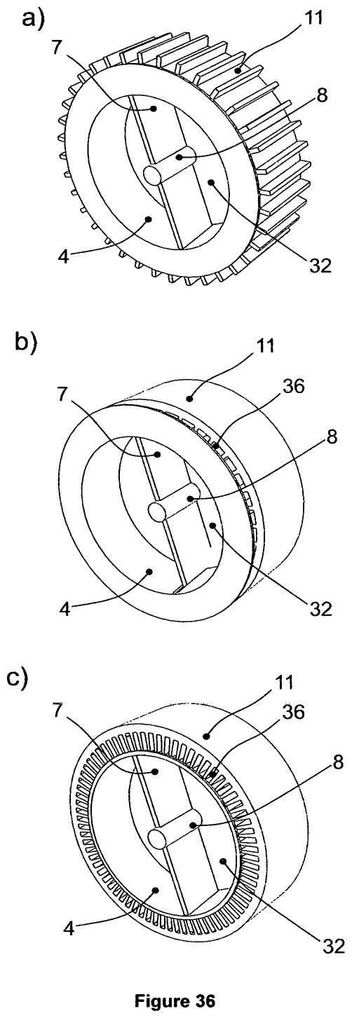

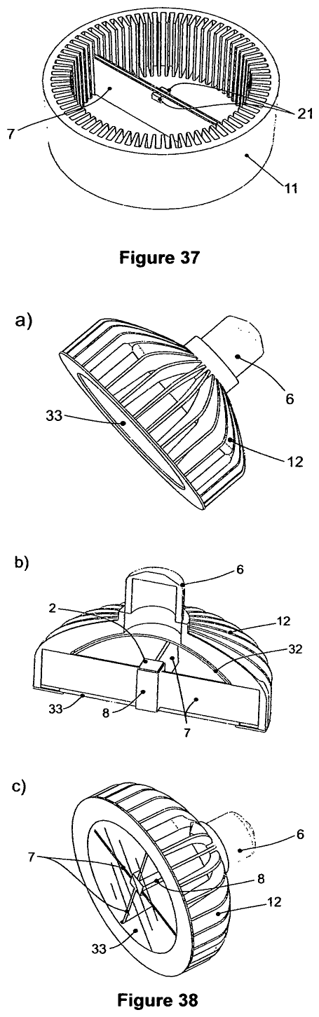

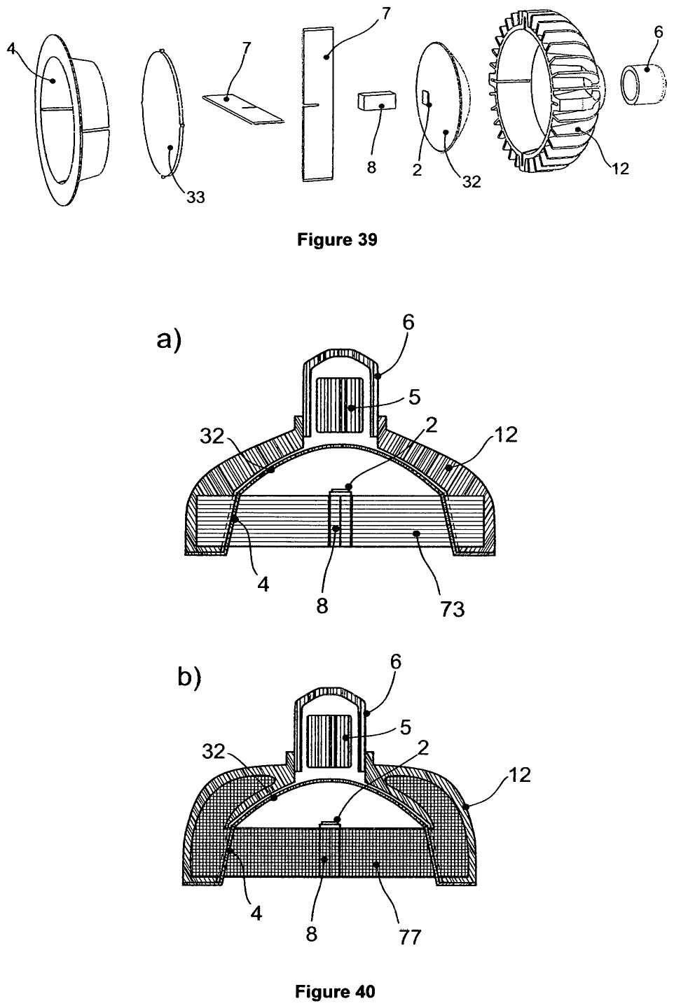

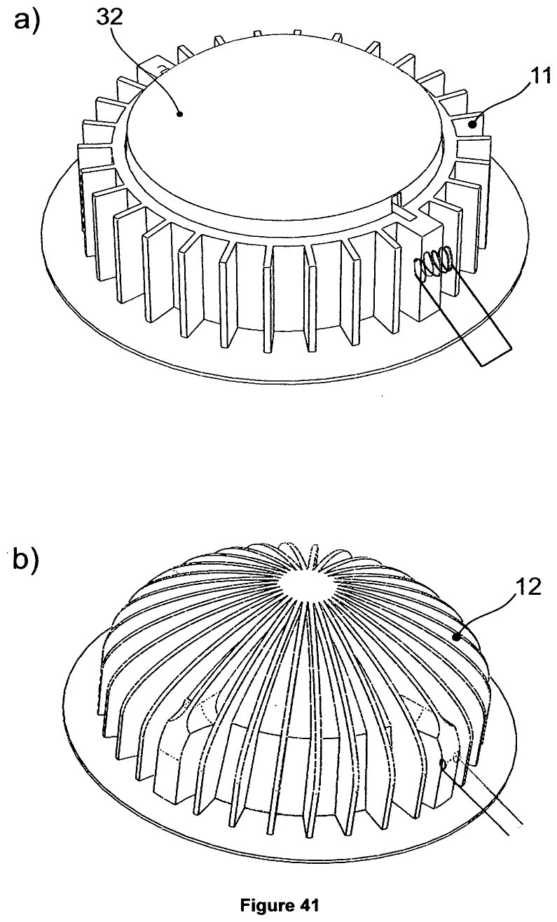

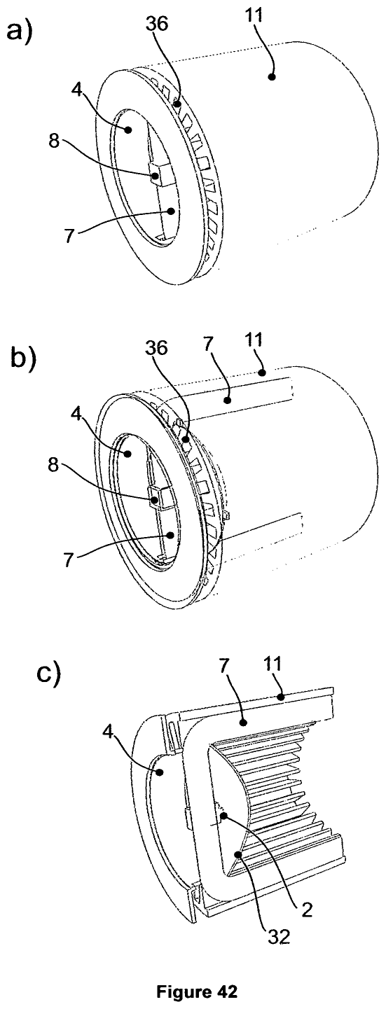

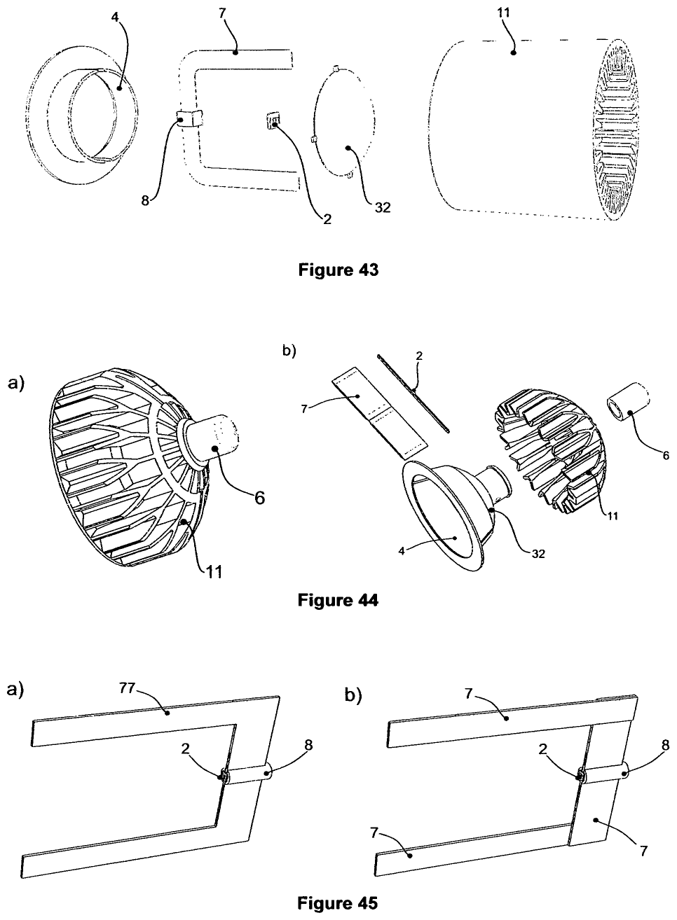

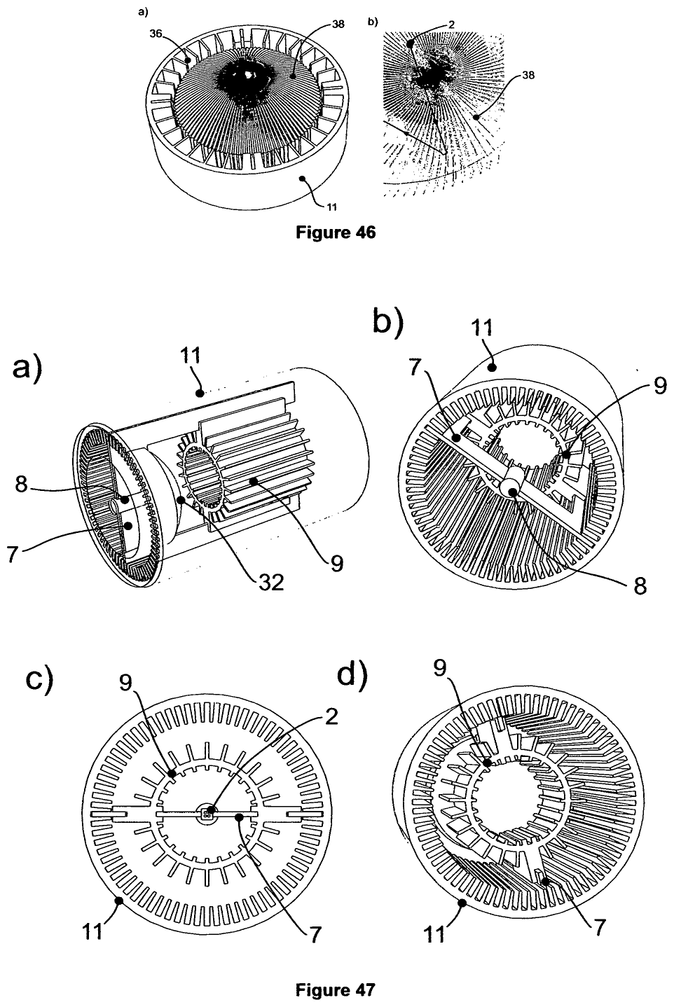

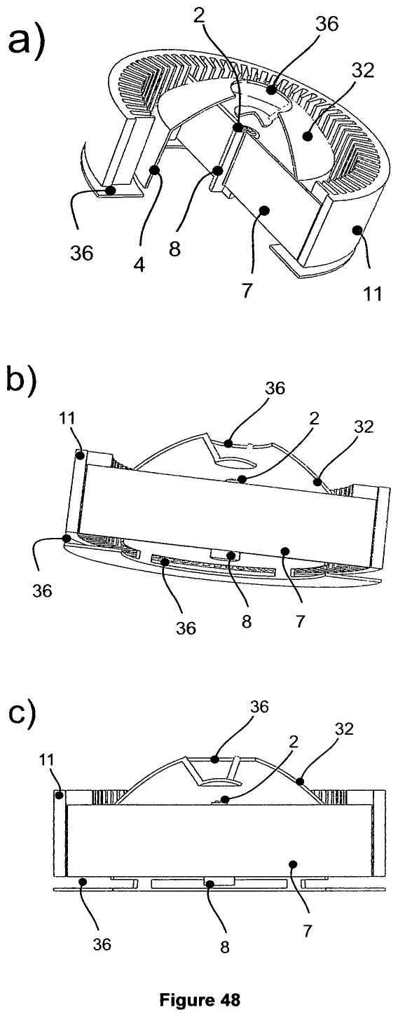

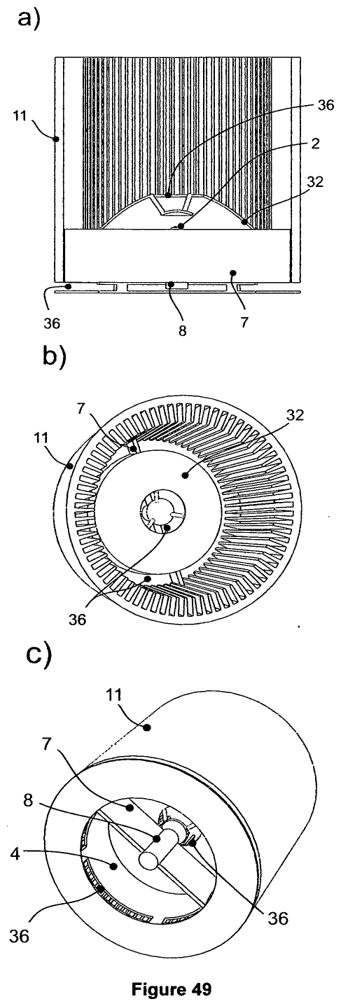

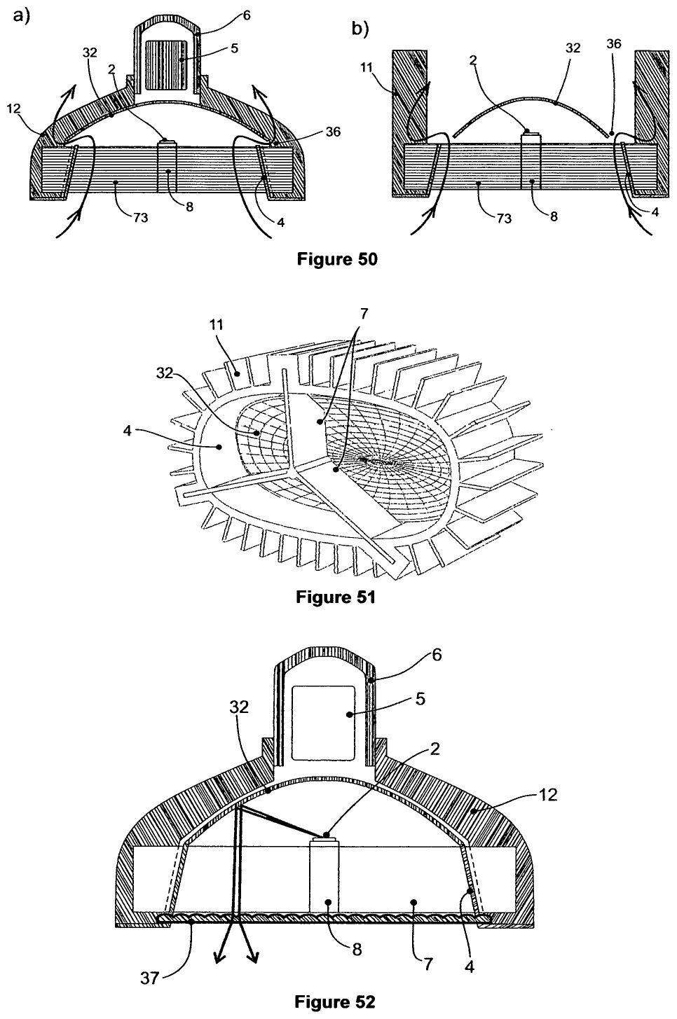

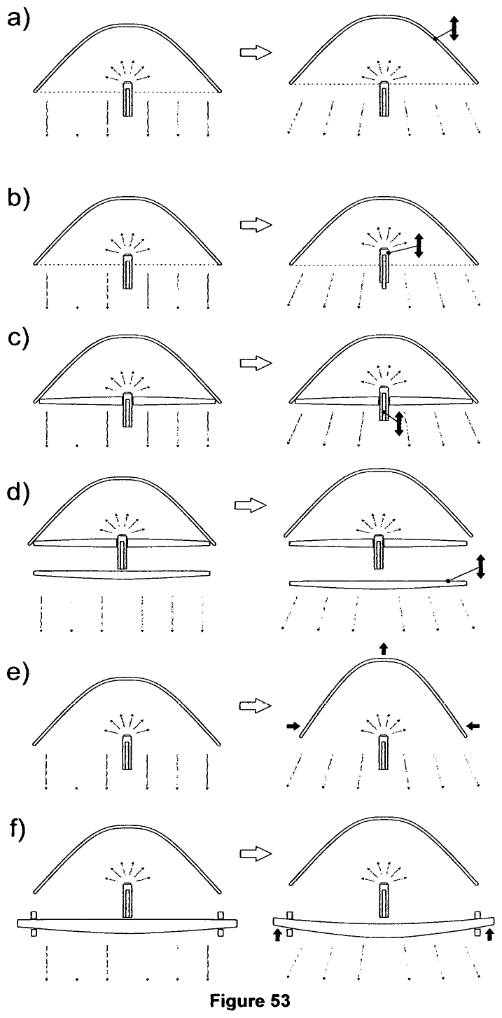

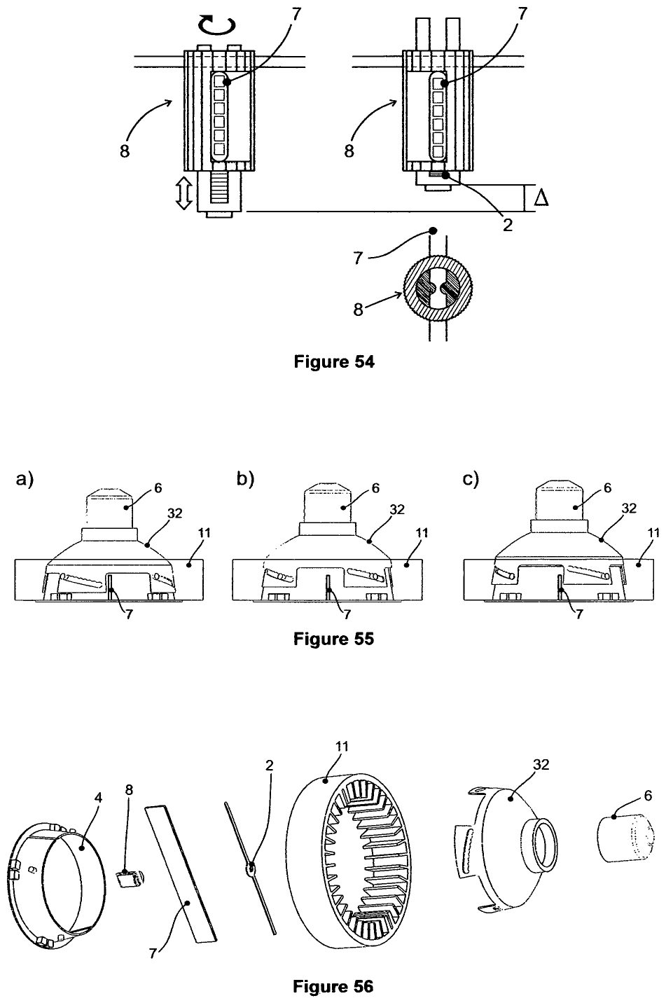

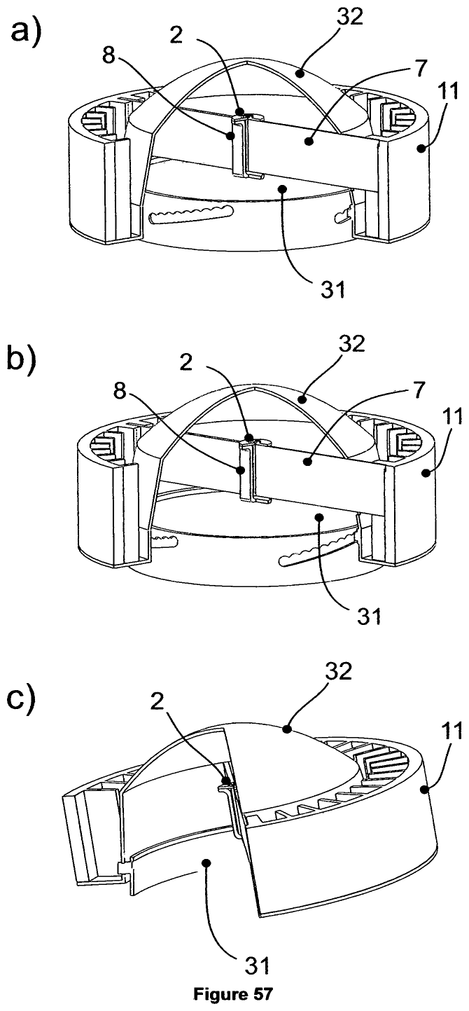

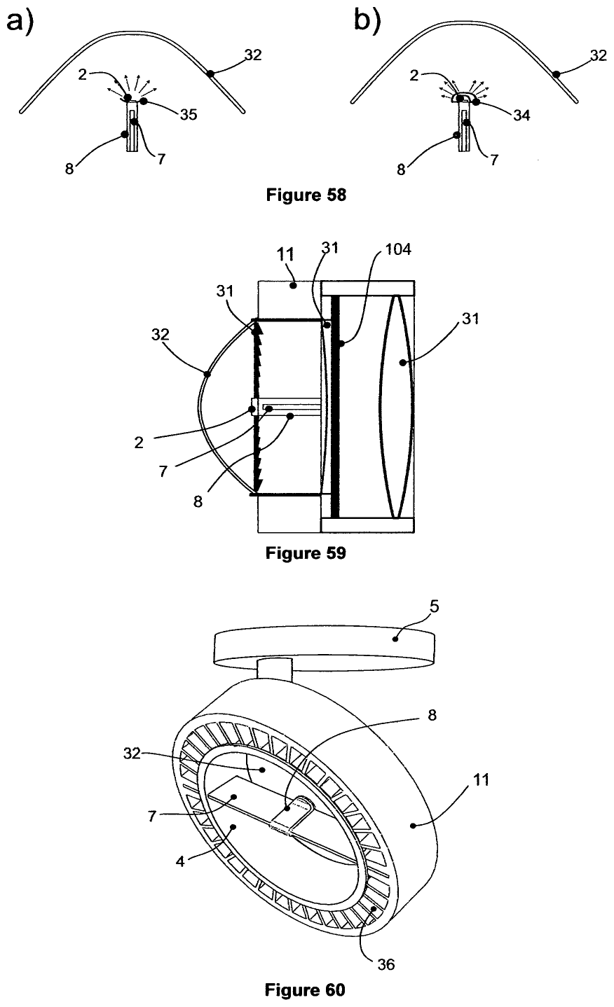

From an optical perspective, the differences existing between the invention solution for LED devices by the use of bidimensional thermal plates in a floating-source configuration comparing current solutions of devices in this configuration using heat pipes is reflected in the two drawings of FIG. 14. Drawing a) illustrates the presently existing solution, which involves greater optical disturbance—and thermal loading—due to the use of a heat pipe (101) within a cladding (102), which interacts with the beam of light coming from the radiation source (2) located below it, when it is reflected in the reflector (32), while drawing b) is a solution with a bidimensional thermal plate (7), which reduces the thermal load by radiation, decreases the optical disturbance and substantially improves the efficiency of the system by decreasing the surface of interaction.

The proposed bidimensional thermal plates (7) are ideally thermal plates by two phase change, of the type shown in FIG. 15 according to a sectional view of the plate. Its construction features allow extremely thin plates, thanks to the internal structural pillars (72), which supports the low internal pressure and allows very small face thicknesses and, in this case, also conform the characteristics of the internal cavities (71) of confinement of the liquid undergoing phase change, such as water or acetone, with a large heat transfer capacity, and without structural width limitations, since they are based on a modular structure.

A comparison of a typical heatpipe (101) slightly crushed (drawing a) with that of a basic bidimensional plate by phase change (drawing b) in the section view is showed in FIG. 16. The heatpipe (101) has some essential constructive limitations when trying to be flattened, since the internal vacuum necessary for its operation causes its faces to be bent, which affects it to lose vacuum and collapse, negatively influence its operation. However, the bidimensional thermal plate, which is characterized by having pillars or 2D or 3D reinforcements (72) between their flat faces capable of supporting the vacuum necessary for the evaporation of the fluid inside it at the working temperature, which is the mechanism to dissipate heat, can be formed according to an extremely thin structure, with very thin material thicknesses, which is an essential advantage over a heatpipe already mentioned in the summary section of the invention.

A thermal plate with one or more structural supports (72), which hold the two flat faces of the hermetic system against the internal vacuum, can be easily modulated and/or sizing up without a detriment of the performance of the system, as schematized in the drawings of FIG. 17. This modularity, which allows a growth of the width of the bidimensional thermal plate according to the needs of the system, is a fundamental improvement with respect to a heatpipe. These pillars can have the additional functionality as wick that supplies the liquid that will be evaporated in the vicinity of the heat source by capillarity.

The bidimensional thermal plates by phase change, which are the essence of the system, can be manufacture by a extrusion profiles (73) of aluminium with longitudinal hollow channels to the direction of extrusion. FIG. 18 shows a cross section of one of these multi-channel thermal plates, with seven channels that act as hermetic chambers (71) with striated walls to improve the capillarity thereof. Power and/or control cables can be inserted through any of these cavities too.

This type of thermal plates can also be manufactured by lamination plates, (77), constituted by a sandwich structure of at least two sheets or thermal conductive films (74) that are hermetically sealed at their ends, or by means of two other external plastic films (75). There are structural supports (72) inside. Different implementations of a phase change bidimensional thermal plate by lamination are represented in FIG. 19: two sheets (74), generally copper or aluminium metal, which embeds: a) two porous layers (76) separated by pillars; b) a porous layer (76) with longitudinal structural combs (72) of the same material; c) a porous layer (76) and a three-dimensional structure with pillars (72) distributed hexagonally with a common platform; d) a mesh that acts as a wick (76) and structural support (72); e) two layers of porous material (76) separated by a metal mesh (72). In the case of variant f) a structure identical to case e) is shown, but embedded and hermetically thermo-sealed by two plastic films (75) outside.

Some distributions of spacers or structural pillars (72) that can support the vacuum pressure of the bidimensional thermal plate, without limitation are showed in FIG. 20. Case a) corresponds to the description of FIGS. 19a and 19c; case b) to FIG. 19b and case c) to FIG. 19d.

System Realizations in Parallel Configuration.

A spotlight's body (a) and an exploded view (b) is showed in FIG. 21 that includes the typical components of the opto-thermal system in parallel configuration: a reflector (32), a radiation source (2), a bidimensional thermal plate (7) bent in the form of symmetrical “U”, an extrusion body (11) with external fins, an internal power supply (5), and a rear closing lid of the body.

This configuration of the system allows the novel incorporation of one or several additional radiators in contact with the internal flat faces of the plate, both in the opposite part where the radiation source is located, and in the lateral parts thereof, which it is represented in FIG. 22 with an spotlight extrusion body (11) of a cylindrical section with internal fins and a bidimensional thermal plate (7), which incorporates additional dissipators (9) in different regions of contact with the thermal plate.

The bidimensional plates can be integrated according to different geometrical shapes, with different types of bodies in parallel configuration, where the main direction of the radiation of the source is parallel to the normal direction of the plate in the region of contact with the radiation source.

As a non-limiting example, the body of a projector with square section and internal fins is showed in FIG. 23, with three subsequent bidimensional thermal plates in contact with all the side faces of the body; two plates in the shape of “L”, and one in the form of “U”, which forms a subsystem of plates in “X”.

Another example is the body of the square-section LED spotlight, without fins, with four lenses (31) supported on a transverse and inner LED plate of FIG. 24, which allows an “X” arrangement of “U” shaped thermal plates on both sides of the plate; solution that increases the transfer in the entire periphery of the body of the system. The main elements of this type of spotlight are those shown in the exploded drawing of FIG. 25.

The laminated bidimensional thermal plates (77) make it possible to simplify the number of components by combining several plates in one, as in the case of the referred two devices.

The plate may have branches to optimize heat transfer in more complex systems, as is the case of FIG. 26, where the laminated bidimensional thermal plate (77) with branches of the FIG. 27 is integrated in parallel configuration.

The body of the spotlight of FIG. 28 is an example of an extrusion body (11) of cylindrical section with external and internal longitudinal fins, in which a bidimensional thermal plate is in a parallel configuration, while the body of the FIG. 29 has longitudinal internal fins and an additional dissipator (9) in its rear part in contact with the bidimensional thermal plate, which increases the capacity of heat dissipation.

A body of cylindrical section based on a standard extrusion tube with a bidimensional thermal plate which, being essentially flat, can be bent slightly to adapt to the surface of the cylindrical body or to be coupled by a thermal blanket, metal support or similar element as in FIG. 30. The attachment system of the elements in the cylinder is similar to the existing solutions in plumbing with a deformable O-ring (103). The main construction elements of the described body are represented in FIG. 31.

As a last example of spotlight with opto-thermal system in parallel configuration the projector of FIG. 32 is showed. It consists of an extrusion body (11) of square section based on a standard extrusion profile with a bidimensional thermal plate posterior to the source of radiation, in the form of “U”, where the elements are anchored to the profile by pressure, by deformation of an O-ring (103). This body does not have fins because its own surface radiates and dissipates the necessary heat so that the source remains at a correct temperature. The essential components of it are visible in the exploded view of FIG. 33.

System Realizations in Floating-Source Configuration.

The main optics can be a superficial or volumetric reflector in floating-source configuration, such as, for example, based on a transparent dielectric material, such as PMMA, PC or silicone, or glass. It can totally or partially embeds the radiation source and/or the thermal plate. These possibilities are summarized in the schemes of FIG. 34; in drawing a) there is a superficial reflector, and the (b) and the (c) ones refer to optics constituted with a transparent volumetric material inside, which protect the optic and/or the source of radiation. The reflection can be done on the surface by the metallic finish of the optical piece or by a micro-prismatic structure that reflects the light by internal total reflection in all cases.

As explained in the summary of the invention, the plate or plates can partially section or intersect the reflector in the floating-source configuration, although the most usual way is that it only intersects with the anti-glare ring, thermally connecting the radiation source to the body. FIG. 35 illustrates different opto-thermal systems in this configuration in front view, with one, two, three and four bidimensional thermal plates of thermal connection between the radiation source and the periphery of the system.

Three different opto-thermal systems in floating-source configuration are showed in FIG. 36: a) with external fins, b) with side ventilation openings (36), and c) with front ventilation openings (36), these last two with internal dissipation fins.

One of the characteristics of this configuration is that the plates can have lateral emitting radiation sources or LEDs (21) whose electronic plate is parallel and coincident with one of the faces of the bidimensional thermal plate, as shown in the device of FIG. 37. The bidimensional thermal plate can even be formed by the electronic plate itself.

A LED lamp of diameter 111 mm with aE27 socket (6) and with the technology of the present invention in a floating-source configuration, with two thermal crossed plates (7) and a flat protective glass (33) in the outlet of the system is showed in FIG. 38. Each half of the plate has an independent thermodynamic system, with independent hermetic chambers, which, in many cases, improves the operation upon change of orientations, since gravity influences the system. An exploded view of the essential components of this type of lamp is showed in FIG. 39.

A comparative view of a lamp with extrusion bidimensional thermal plate (drawing a), and a lamp with laminated bidimensional thermal plate (drawing b) is showed in FIG. 40. The latter allows greater flexibility of forms, since it is adapted to particular designs. The body material is injected aluminium (12) and is designed in two halves in both cases, where, once the plate and the reflectors are inserted, they are joined to form a single set to press the thermal plate as a sandwich.

A recessed downlight ceiling luminaire that implements the opto-thermal system in a floating-source configuration is showed in FIG. 41.

The plates are generally straight in floating-source configuration as in referred drawings. However, they can be curved in more optimized constructions, as, for example, in the form of “U”, as seen in the spotlight of FIG. 42, whose essential elements are represented in FIG. 43; namely: antiglare ring (4), platform (6) of the heat source (2) LED, bidimensional thermal plate (7), reflector (32) and extrusion body (11).

A LED lamp based on the inventive system is showed in FIG. 44, with a body from an extrusion profile (11) and a machining process. The printed circuit of the LED is directly coupled to the edge of the bidimensional thermal plate (7) divided into two halves. Both halves of the plate have independent hermetic chambers (where the fluid is located), since the system is more robust upon changes of orientation. Similar heatsink can also be manufactured by means of an aluminium flat plate by press-stuffing.

Two possible subsystems of thermal plates that can be integrated in a spotlight in a floating-source configuration are showed n FIG. 45: laminated bidimensional plate (77) as mono-component “U” (drawing a), and a set of three simple plates that replace a mono-component plate in “U” (drawing b). The latter may be more convenient for manufacturing costs, although it is also possible to curve a bidimensional thermal plate of extrusion to give a similar piece, with some rounding, as in FIG. 43.

As it has been seen (FIG. 34), the main optics can be constituted by a superficial or volumetric, metallized or prismatic reflector. An example of optics with micro-prismatic reflector (38), which allows to reflect and direct the light by means of a transparent dielectric by internal total reflection, is found in the device of FIG. 46. The image on the right (b) shows a detail of this reflector based on transparent materials with micro-prismatic surfaces, which reflects the light emitted by the radiation source (2) by internal total reflection. These micro-prisms can be more complex, not necessarily aligned with the radii of the reflector nor with the same length.

FIG. 47 illustrates a way in which an additional heat radiator (9) can be integrated into the interior of the body connected to a bidimensional flat thermal plate, longitudinally to the body, which transfers the heat from the radiation source to the external body and the internal fins of the additional heatsink. In this case all these fins are longitudinal to the air flow, which helps the transfer of heat. Components have been removed in some drawings for a better understanding of them, such as the optical system.

As said, it is possible to create a ventilation opening in the central region of the reflector to favour air flow and, consequently, the cooling of the system without significantly disturbing the optical characteristics in floating-source configuration. FIG. 48 shows the main components of a simplified AR111 lamp with central opening (36) for said purpose, and FIG. 49 the body of a spotlight with central opening (36) in the main reflector.

It is also possible to allow an air flow between the anti-glare ring and the optics, as shown in the drawings of FIG. 50, which correspond to the cross-sectional view of a lamp (drawing a) and a spotlight (drawing b) with a thermal plate in a floating-source configuration, which helps air flow and heat transfer.

An example of a projector with bidimensional thermal plate, where the reflector does not present symmetries, is shown in FIG. 51. This type of systems can be integrated as vehicle headlights or vials illumination in a way that avoids direct glare of the radiation source.

The distributions of light radiation can be modified by inserting additional components into the optics, or by mechanically influencing the shape of the reflector and/or its relative position on the axial axis with respect to the source of radiation.

The schematic drawing of FIG. 52 shows a device with a thermal plate incorporating a thin refractive optic composed of a matrix of micro-lenses (37) that make up the output light beam. This micro-structure can be rotated or displaced, so that, together with a faceted or micro-structured reflector or lens, it modulates the distribution of light.

Six strategies of floating-source optical systems that allow the output light beam to be varied, either manually, or by means of actuators and motors, by axial displacement: a) of the reflector, b) of the platform, c) of the plate, d) of the lens or micro-lens matrix, or by deformation of e) the reflector, of) the lens are showed in FIG. 53. The first scheme (a) illustrates an optical system with an axially mobile reflector that changes light distribution depending on the position of the reflector. The following illustrations (b and c) are similar, except that the platform and the thermal plate are displaced longitudinally, respectively. Case d) shows a moving lens to manipulate the distribution. FIGS. 54, 55, 56 and 57 illustrate some details of the manipulator systems of the described beam.

FIG. 54 shows the detail of a variable beam optical system with regulation of the positioning of the radiation source, fixed to its platform, which is displaced axially by rotating it. This detail illustrates an example of mechanical implementation of the system depicted in FIG. 53b.

A system with a mobile mechanism that allows an axial displacement of the reflector with respect to the radiation source thanks to guides in the reflector or thread in showed in FIG. 55, which provides a regulation of the distribution of the light beam. It is not necessary that these guide through the piece forming an opening. The anti-glare fence is integral with the body of the system. The system is an example of implementation of the system represented in FIG. 53a.

The essential parts of the system of the previous figure are showed in FIG. 56, where the

PCB of the radiation source comprises a large part of the edge of the thermal board and contains five LEDs: red, green, blue and amber, and a sensor of presence in the centre.

An implementation of an opto-thermal system in a floating-source configuration with variable beam optics by a fixed reflector and an axially movable lens is showed in FIG. 57. This system is a possible implementation of those shown in FIG. 53d.

Examples of thermal plates that incorporate an initial optics close to the source of radiation are showed in FIG. 58 with: a) a mini-reflector (35) and b) a mini-lens (34), both close to the radiation source to adapt the radiation directed to the reflector, to protect the radiation source and/or to shield the direct view of radiation from the source due to optical leakage.

A diagram of the opto-thermal system of invention in a floating-source configuration associated with a system for projecting images by light transmission, such as an LCD or a gobo (104), with one or more lenses (31), which can be mobile to adapt the image correctly on the surface to be projected, is showed in FIG. 59. This floating-source configuration also allows the illumination of DMD chips to represent images by reflection. A similar system with an elliptical, or pseudo-elliptical optics can be integrated as a subsystem for the injection of light into optical fibre.

Preferential Execution of the System.

Without limitation, one of the preferred embodiments is a compact spotlight with adjustable light beam with bidimensional thermal plate in the floating-source configuration of FIG. 60, constituted by a bidimensional thermal plate (7) in an aluminium extrusion body (11), an anti-glare ring (4), a reflector (32) with essentially cylindrical symmetry, a platform (8) located in the central part of the plate, a LED radiation source (2) integrated in the platform, and a dimmable power supply (5), so that the heat generated by the LED is efficiently transferred to the outermost part of the system, additionally characterized in that:

The bidimensional thermal plate has its flat faces and is multichannel, so that each channel is separated by a structural wall (72) essentially perpendicular to the face of the plate, which bears the pressure from the outside, and each channel (71) is hermetically sealed, partially filled with acetone.

The aluminium extrusion body of the luminaire has an essentially circular section, with internal fins, and has grooves with flat faces where part of the thermal plate is inserted, which allows direct and flat contact between the thermal plate and the body.

The system is in floating-source configuration so that the LED radiates perpendicular to the faces of the plate and faces a reflector that redirects all the radiation coming from the LED.

1. Opto-thermal system based on bidimensional thermal plates, applicable to electromagnetic radiation devices with heat dissipating elements, essentially constituted by a body (1) with at least one flat face, which can be manufactured by extrusion (11), or injection (12), from one or several parts, with or without internal and/or external heat dissipation fins or radiators, and with or without openings on its front, side, rear, or in several of these parts as cooling-inlets; a radiation source (2), such as an LED, RGB, or IR and/or UV source, which can incorporate one or more radiation, colour, presence, or proximity sensors; an optics (3), formed by one or more lenses (31), matrix or arrays of micro-lenses (37) and/or one or more reflectors (32) surface or solid of transparent material, with a reflector coating or based on micro-prisms (38); a power supply unit (5), except for radiation sources that do not require it, such as AC LEDs, and/or electronic power supply and/or control equipment regulated by a microcontroller or a microprocessor; and, preferably, with an anti-glare ring (4), a protective transparent glass, sheet or film (33) at the radiation exist and an interconnectivity of the socket or connector type (6); characterized by integrating a bidimensional thermal plate with flat faces (7), straight or bent in various geometric shapes, of a conductive material, by phase change or thermal conduction, or several of these plates joined together by their middle part, which transmit the heat generated by the radiation source, which is in a central region of the system in thermal contact with a central area of the plate or in the union of plates, to peripheral regions at the ends of the plate or plates, which they extend along the side, back, front or several of these zones of the system, by contact of the flat faces of the plates with flat faces of the fins, radiators or other parts of the body of the device.

2. Opto-thermal system based on bidimensional thermal plates, according to claim 1, characterized by including a base or platform (8) of a heat conducting material, by thermal conduction or by phase change, attached to the plate or union of plates that thermally connects them with the source of radiation.

3. Opto-thermal system based on bidimensional thermal plates, according to the first and second claims, characterized by including one or more additional internal heat radiators (9) in thermal contact with the thermal plate or plates, in the part adjacent to the radiation source, and/or on the side of the body of the device, and/or one or more external heat radiators in the front or back, and/or a complementary active dissipation subsystem by fan, vibrating membrane or Peltier cell, the latter integrated between the surface where the radiation source, or the platform, and the thermal plate, or between the radiation source and the platform.

4. Opto-thermal system based on bidimensional thermal plates, according to claims 1 to 3, characterized in that the plates (7) are thermal plates by phase change, constituted by a hollow body of flat and thin external faces, with supports or structural supporting pillars (72), and with one or several hermetically sealed cavities (71) that confine a liquid, such as acetone or water, which absorbs and transmits the heat generated by the radiation source towards all the extension of the thermal plate by change of phase and evaporation.

5. Opto-thermal system based on bidimensional thermal plates, according to claim 4, characterized in that the thermal plate or phase change plates are constituted by extrusion profiles (73), preferably aluminium, with longitudinal hollow channels along the direction of extrusion of each plate or half of the plate.

6. Opto-thermal system based on bidimensional thermal plates, according to claim 4, characterized in that the phase change thermal plate(s) consist of a sandwich laminated structure of two sheets or thermally conductive films (74), of different materials and textures, preferably of copper or aluminium, with one or several internal hollow cavities, hermetically sealed at their ends, or sealed by means of two other outer plastic films (75), such as PET, by a vacuum thermo-welding process, with several structural supports (72), wherein a second layer of porous structure (76) may be internally adhered to said conductive films or films, which may preferably be a copper mesh, copper metal foam film, or the resulting structure of a process of sintered of metallic powder that, by capillarity, is wetted by the fluid and makes the function of wick.

7. Opto-thermal system based on bidimensional thermal plates, according to previous claim 6, characterized in that the channel or the internal channels of the laminated thermal plates can be in closed loop.

8. Opto-thermal system based on bidimensional thermal plates, according to claims 1 to 3, characterized in that the bidimensional thermal plate or plates (7) are solid plates composed of one or more materials with high thermal conductivity, either of materials metallic, ceramic, crystalline, quasi-crystalline, such as copper, aluminium, boron nitride, aluminium nitride, graphite, graphene or carbon nanotubes, including composite materials, or combinations thereof, either in the form of a single plate, or in form of a multilayer plate formed by several layers or films derived from these.

9. Opto-thermal system based on bidimensional thermal plates, according to claims 1 to 8, characterized in that they are presented in “parallel configuration”, that is, the main radiation direction of the radiation source (2) is parallel to the normal direction of the surface of the plate(s) in the contact region between the source and the plate.

10. Opto-thermal system based on bidimensional thermal plates, according to previous claim 9, characterized in that the plates are bent, by their flat faces or by their edges, with “U” shaped, “L” shaped, or “X” shaped, with a laminated plate with branches or with several plates.

11. Opto-thermal system based on bidimensional thermal plates, according to claims 1 to 8, characterized in that it is presented in “floating-source configuration”, that is, the main radiation direction of the radiation source (2), which is suspended and held by the plate or plates, is perpendicular to the normal direction of the faces of the plate or plates in the contact region between the source and the plate, interacting all the radiation with a reflector in front of the source.

12. Opto-thermal system based on bidimensional thermal plates, according to the claim 11, characterized in that the plate or plates have lateral emission radiation sources (21) whose base or PCB (printed circuit board) is coincident with any of the two faces of the plate, or are part of it.

13. Opto-thermal system based on bidimensional thermal plates, according to claims 11 to 12, characterized in that has an additional optics close to the radiation source, such as a mini-lens (34) or a mini-reflector (35).

14. Opto-thermal system based on bidimensional thermal plates, according to claims 11 to 13, characterized in that there is a ventilation opening (36) in the central region of the reflector, in the vertical of the radiating source coupled to the plate.) that allows a flow of air, gas or liquid from the environment.

15. Opto-thermal system based on bidimensional thermal plates, according to claims 11 to 14, characterized in that the plate (7), the platform, the radiation source, the optics, or several of these elements are axially movable, so that the distribution of the exit radiation can be modified by moving these moving optical elements along its axial axis.

16. Opto-thermal system based on bidimensional thermal plates, according to claims 11 to 13, characterized in that the plate (7), with the platform and/or radiation source, is linked with a flexible lens or reflector, so that the distribution of the radiation can be modified by a deformation, by pressure, of these flexible elements.

17. Opto-thermal system based on bidimensional thermal plates, according to claims 11 to 16, characterized in that the plates (7) are flat and rectangular, being able to section or partially intersect the optical reflector, and/or the anti-glare ring.

18. Opto-thermal system based on bidimensional thermal plates according to claims 11 to 17, characterized by an arrangement of cross or star plates that converge in the region where the radiation source is located.

19. Opto-thermal system based on bidimensional thermal plates, according to claims 17 and 18, characterized in that the plates are bent at their edges in “U” shape, and/or “L” shape, and inserted in grooves with the flat faces of the body of the device.

20. Opto-thermal system based on bidimensional thermal plates constituted by a plurality of subsystems according to all the preceding claims, characterized by a particular spatial and/or angular distribution of these subsystems, as in a linear or bidimensional matrix
